(19) United States
(12) Patent Application Publication
(10) Pub. No.: US 2025/0371720 A1
(43) Pub. Date: Dec. 4, 2025

(54) INFORMATION PROCESSING METHOD, RECORDING MEDIUM, INFORMATION PROCESSING SYSTEM, AND INFORMATION TERMINAL

(71) Applicant: Panasonic Intellectual Property Management Co., Ltd., Osaka (JP)

(72) Inventors: Motoshi Anabuki, Hyogo (JP); Yusuke Kushiki, Osaka (JP); Shunsuke Kuhara, Osaka (JP); Yoshimasa Honda, Hyogo (JP)

(21) Appl. No.: 19/295,783

(22) Filed: Aug. 11, 2025

Related U.S. Application Data
(63) Continuation of application No. PCT/JP2024/002294, filed on Jan. 25, 2024.

(30) Foreign Application Priority Data
Feb. 15, 2023 (JP) 2023-021571

(51) Int. Cl. G06T 7/246; G06T 7/73

(52) U.S. Cl. CPC G06T 7/246; G06T 7/73; G06T 2207/10016; G06T 2207/30236

(57) ABSTRACT

An information processing method executed by a computer, the information processing method including: obtaining first information related to a region where each of one or more mobile objects is present; extracting one or more first regions where the one or more mobile objects are present, among a plurality of regions, based on the first information obtained; and outputting second information related to each of the one or more first regions extracted.

### CROSS REFERENCE TO RELATED APPLICATIONS

This is a continuation application of PCT International Application No. PCT/JP2024/002294 filed on Jan. 25, 2024, designating the United States of America, which is based on and claims priority of Japanese Patent Application No. 2023-021571 filed on Feb. 15, 2023. The entire disclosures of the above-identified applications, including the specifications, drawings and claims are incorporated herein by reference in their entirety.

### FIELD

The present disclosure relates to an information processing method, a recording medium, an information processing system, and an information terminal for presenting information related to a mobile object.

### BACKGROUND

Patent Literature (PTL) 1 discloses a remote operation system. This remote operation system includes a mobile robot and an operation terminal that mutually communicates with the mobile robot. The mobile robot transmits, to the operation terminal, monitor image information that is based on an image captured by a camera. The operation terminal receives the monitor image information and displays, on a terminal display, an operation screen including a monitor image that is based on the captured image.

### CITATION LIST

### Patent Literature

PTL 1: Japanese Unexamined Patent Application Publication No. 2022-78760

### SUMMARY

### Technical Problem

When a user who manages a mobile robot (mobile object) such as the one disclosed in PTL 1 wants to grasp the usage status of the mobile robot, for example, it is considered that all items of information related to the entire area where the mobile robot is used are shown all at once on the display.

However, when the area where one or more mobile robots (mobile objects) are used includes a large number of floors, such as in a high-rise building, for example, displaying items of information related to all the floors on the display all at once makes it more difficult for the user to grasp the usage status of the one or more mobile robots. Also, when the area where one or more mobile robots are used is a relatively large site, for example, displaying all items of information related to the entire site on the display all at once makes it more difficult for the user to grasp the usage status of the one or more mobile robots.

In view of the above, the present disclosure provides an information processing method and so forth that enable a user to easily grasp the usage status of one or more mobile objects.

### Solution to Problem

An information processing method according to an aspect of the present disclosure is an information processing method executed by a computer, the information processing method including: obtaining first information related to a region where each of one or more mobile objects is present; extracting one or more first regions where the one or more mobile objects are present, among a plurality of regions, based on the first information obtained; and outputting second information related to each of the one or more first regions extracted.

These general or specific aspects may be implemented using a system, a method, an integrated circuit, a computer program, or a computer-readable recording medium such as a CD-ROM, or any combination of systems, methods, integrated circuits, computer programs, or recording media.

### Advantageous Effects

With the information processing method and so forth according to an aspect of the present disclosure, it is possible for a user to easily grasp the usage status of one or more mobile objects.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 is a block diagram showing an example of an information processing system according to an embodiment.

FIG. 2 is a diagram for describing a problem.

FIG. 3 is a flowchart showing an example of a basic operation performed by the information processing system according to the embodiment.

FIG. 4 is a diagram showing examples of position information and area information.

FIG. 5 is a diagram showing Display Example 1 in the example of the basic operation.

FIG. 6 is a diagram showing Display Example 2 in the example of the basic operation.

FIG. 7 is a diagram showing Display Example 3 in the example of the basic operation.

FIG. 8 is a diagram showing Display Example 4 in the example of the basic operation.

FIG. 9 is a flowchart showing an operation performed in Working Example 1 of the information processing system according to the embodiment.

FIG. 10 is a diagram showing other examples of the position information and the area information.

FIG. 11 is a flowchart showing an operation performed in Working Example 2 of the information processing system according to the embodiment.

FIG. 12 is a diagram showing examples of route information.

FIG. 13 is a diagram showing Display Example 1 in Working Example 2.

FIG. 14 is a diagram showing Display Example 2 in Working Example 2.

FIG. 15 is a diagram showing Display Example 3 in Working Example 2.

FIG. 16 is a diagram showing Display Example 4 in Working Example 2.

FIG. 17A is a diagram showing an entire screen of Display Example 5 in Working Example 2.

FIG. 17B is a diagram showing a detailed screen of Display Example 5 in Working Example 2.

FIG. 18 is a flowchart showing an operation performed in Working Example 3 of the information processing system according to the embodiment.

FIG. 19 is a diagram showing examples of state information.

FIG. 20 is a flowchart showing an operation performed in Working Example 4 of the information processing system according to the embodiment.

FIG. 21 is a diagram showing an example of inter-area movement information.

FIG. 22 is a diagram showing an example display in Working Example 4.

FIG. 23 is a flowchart showing an operation performed in Working Example 5 of the information processing system according to the embodiment.

FIG. 24 is a diagram showing an example of passing area information.

FIG. 25 is a diagram showing Display Example 1 in Working Example 5.

FIG. 26 is a diagram showing Display Example 2 in Working Example 5.

FIG. 27 is a flowchart showing an operation performed in Working Example 6 of the information processing system according to the embodiment.

FIG. 28 is a diagram showing examples of intervention information.

FIG. 29 is a flowchart showing another operation performed in Working Example 6 of the information processing system according to the embodiment.

FIG. 30 is a diagram showing other examples of the intervention information.

FIG. 31 is a diagram showing a display example in Working Example 6.

FIG. 32 is a diagram for describing an entry of the intervention information using an information terminal.

FIG. 33 is a flowchart showing an operation performed in Working Example 7 of the information processing system according to the embodiment.

FIG. 34 is a diagram showing examples of notification information.

FIG. 35 is a diagram showing a display example in Working Example 7.

FIG. 36 is a flowchart showing an operation performed in Working Example 7 of the information processing system according to the embodiment.

FIG. 37 is a diagram showing an example of traffic information.

FIG. 38 is a diagram showing a display example in Working Example 8.

FIG. 39 is a flowchart showing an operation performed in Working Example 9 of the information processing system according to the embodiment.

FIG. 40 is a diagram showing other examples of the state information.

FIG. 41 is a diagram showing a display example in Working Example 9.

FIG. 42 is a diagram showing Variation 1 of a display shown on a display of the information terminal.

FIG. 43 is a diagram showing Variation 2 of the display shown on the display of the information terminal.

FIG. 44 is a diagram showing Variation 3 of the display shown on the display of the information terminal.

FIG. 45 is a diagram showing Variation 4 of the display shown on the display of the information terminal.

FIG. 46 is a diagram showing Variation 5 of the display shown on the display of the information terminal.

FIG. 47 is a diagram showing another variation of the display shown on the display of the information terminal.

FIG. 48 is a diagram showing further another variation of Variation 1 of the display shown on the display of the information terminal.

### DESCRIPTION OF EMBODIMENT

The information processing method according to a first aspect of the present disclosure is an information processing method executed by a computer. This information processing method includes: obtaining first information related to a region where each of one or more mobile objects is present; extracting one or more first regions where the one or more mobile objects are present, among a plurality of regions, based on the first information obtained; and outputting second information related to each of the one or more first regions extracted.

With this, it is possible to present, to the user, not all items of information related to the plurality of regions, but only information related to each of the one or more first regions where the one or more mobile objects are present. This achieves the advantage that the user can easily grasp the usage status of each of the one or more mobile objects.

Also, in the information processing method according to a second aspect of the present disclosure, for example, in the first aspect, the second information includes at least one of: information indicating a map of each of the one or more first regions; or information indicating a position of each of the one or more mobile objects in the one or more first regions.

With this, it is possible to present, to the user, at least one of the map of each of the one or more first regions where the one or more mobile objects are present or the position of each of the one or more mobile objects. This achieves the advantage that the user can more easily grasp the usage status of each of the one or more mobile objects.

Also, the information processing method according to a third aspect of the present disclosure further includes, for example, in the first or second aspect, obtaining route information related to at least one of a movement route or a movement range of each of the one or more mobile objects. This information processing method further includes: extracting one or more second regions, among the plurality of regions, based on the route information obtained, the one or more second regions each being a region where the one or more mobile objects have been present before the obtaining of the first information or where the one or more mobile objects can be present after the obtaining of the first information; and outputting third information related to each of the one or more second regions extracted.

With this, it is also possible to present, to the user, information related to each of the one or more second regions where the one or more mobile objects were present in the past or the one or more mobile objects can be present in the future. This achieves the advantage that the user can more easily grasp the usage status of each of the one or more mobile objects.

Also, in the information processing method according to a fourth aspect of the present disclosure, for example, in the third aspect, at least one of the second information or the third information includes information indicating at least one of the movement route or the movement range of each of the one or more mobile objects.

With this, it is possible to present, to the user, the movement route or the movement range of each of the one or more mobile objects. This achieves the advantage that the user can more easily grasp the usage status of each of the one or more mobile objects.

Also, in the information processing method according to a fifth aspect of the present disclosure, for example, in any one of the first to fourth aspects, the first information includes information indicating a position of each of the one or more mobile objects. In this information processing method, the one or more first regions are extracted based on the information indicating the position of each of the one or more mobile objects.

This achieves the advantage of being able to extract one or more first regions, even when each of the one or more mobile objects does not have information that directly indicates the region where such mobile object is present.

Also, the information processing method according to a sixth aspect of the present disclosure further includes, for example, in any one of the first to fifth aspects, obtaining state information related to a state of each of the one or more mobile objects. In this information processing method, the one or more first regions are extracted further based on the state information obtained.

With this, it is possible to extract only information related to the first region where a mobile object in a situation that should be grasped is present among the one or more mobile objects, and present such information to the user. This achieves the advantage of eliminating the user's trouble of grasping unnecessary information.

Also, the information processing method according to a seventh aspect of the present disclosure further includes, for example, in any one of the first to sixth aspects, calculating a priority of each of the one or more first regions. The second information includes information indicating the priority of each of the one or more first regions that has been calculated.

With this, it is possible to present, to the user, information that is responsive to the priority of each of the one or more first regions. This achieves the advantage that the user can easily grasp the region whose priority is high for the user.

Also, in the information processing method according to an eighth aspect of the present disclosure, for example, in the seventh aspect, the one or more mobile objects are a plurality of mobile objects. This information processing method further includes obtaining route information related to at least one of a movement route or a movement range of each of the plurality of mobile objects. In this information processing method, the priority of each of the one or more first regions is calculated based on the route information obtained, to cause a priority of a region where two or more of the plurality of mobile objects pass each other to become high, among the plurality of regions.

With this, it is possible to preferentially present, to the user, the region where two or more mobile objects will pass each other. This achieves the advantage that the user can easily grasp the region whose priority is high for the user.

Also, the information processing method according to a ninth aspect of the present disclosure further includes, for example, in the seventh or eighth aspect, obtaining intervention information indicating that an operator who is remotely monitoring the one or more mobile objects has intervened. In this information processing method, the priority of each of the one or more first regions is calculated based on the intervention information obtained, to cause a priority of a region where the operator has intervened to become high.

With this, it is possible to preferentially present, to the user, the region where the operator has intervened. This achieves the advantage that the user can easily grasp the region whose priority is high for the user.

Also, the information processing method according to a tenth aspect of the present disclosure further includes, for example, in any one of the seventh to ninth aspects, obtaining notification information indicating that a notification has been provided from the one or more mobile objects to an operator who is remotely monitoring the one or more mobile objects. In this information processing method, the priority of each of the one or more first regions is calculated based on the notification information obtained, to cause a priority of a region where the notification has been provided to the operator to become high.

With this, it is possible to preferentially present, to the user, the region where the notification has been provided to the operator. This achieves the advantage that the user can easily grasp the region whose priority is high for the user.

Also, the information processing method according to an eleventh of the present disclosure further includes, for example, in any one of the seventh to tenth aspects, obtaining traffic information related to traffic in each of the one or more first regions. In this information processing method, the priority of each of the one or more first regions is calculated based on the traffic information obtained, to cause a priority of a region with a large traffic volume to become high.

With this, it is possible to preferentially present, to the user, the region with a large traffic volume. This achieves the advantage that the user can easily grasp the region whose priority is high for the user.

Also, the program according to a twelfth aspect of the present disclosure causes a computer to execute the information processing method in any one of the first to eleventh aspects.

With this, it is possible to present, to the user, not all items of information related to the plurality of regions, but only information related to each of the one or more first regions where the one or more mobile objects are present. This achieves the advantage that the user can easily grasp the usage status of each of the one or more mobile objects.

Also, the information processing system according to a thirteenth aspect of the present disclosure includes an obtainer, a processing unit, and an outputter. The obtainer obtains first information related to a region where each of one or more mobile objects is present. The processing unit extracts one or more first regions where the one or more mobile objects are present, among a plurality of regions, based on the first information obtained by the obtainer. The outputter outputs second information related to each of the one or more first regions extracted by the processing unit.

With this, it is possible to present, to the user, not all items of information related to the plurality of regions, but only information related to each of the one or more first regions where the one or more mobile objects are present. This achieves the advantage that the user can easily grasp the usage status of each of the one or more mobile objects.

Also, the information terminal according to a fourteenth aspect of the present disclosure includes a display, a communicator, and a terminal processing unit. The communicator communicates with the information processing system according to claim 13 to obtain the second information from the information processing system. The terminal processing unit causes the display to display the second information obtained by the communicator.

With this, it is possible to present, to the user, not all items of information related to the plurality of regions, but only information related to each of the one or more first regions where the one or more mobile objects are present. This achieves the advantage that the user can easily grasp the usage status of each of the one or more mobile objects.

### Embodiment

The following describes an information processing system and an information processing method according to an embodiment.

### [1. Configuration]

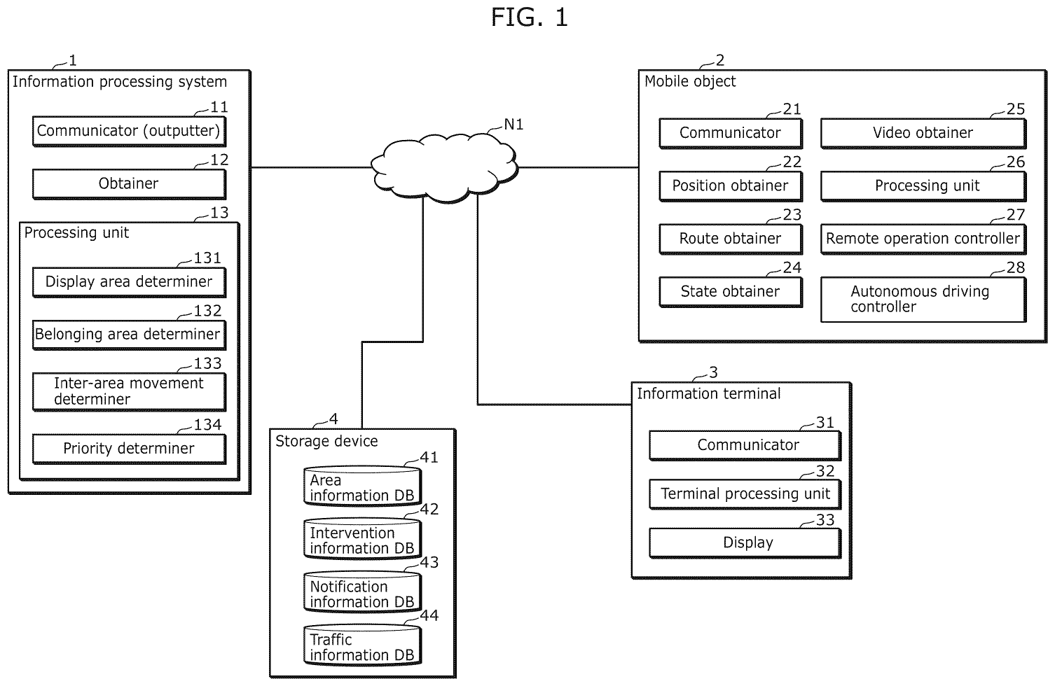

FIG. 1 is a block diagram showing an example of information processing system 1 according to the embodiment. Information processing system 1 is a system for outputting information related to mobile object 2.

Examples of mobile object 2 include an autonomous mobile robot, such as an automatic delivery robot. Other examples of mobile object 2 than an autonomous mobile robot can include an autonomous mobile vehicle, such as an automobile and an automatic motorcycle. In the embodiment, mobile object 2 is not fully autonomous, but is remotely monitored by an operator (user) via a remote control system. In some cases, mobile object 2 can also move in response to a remote operation performed by an operator via the remote control system. The following description assumes that mobile object 2 is an automatic delivery robot, which is, in particular, an automatic monitoring robot that patrols and monitors a facility or a site.

Note that mobile object 2 is not limited to the autonomous mobile object as described above, and may be, for example, a manually driven mobile object capable of being manually operated by a driver aboard such mobile object 2. Also, the task executed by mobile object 2 is not limited to the monitoring described above, and may be, for example, other tasks such as cleaning, delivering, selling, or advertising.

Here, the remote control system is a system operated by a server device or a remote control center where one or more operators stay, and is a system for each operator to remotely monitor, and, in some cases, to remotely operate one or more mobile objects 2. Each operator monitors the status of each mobile object 2 shown on display 33, using, for example, information terminal 3 such as a personal computer. Also, each operator remotely operates mobile object 2 in response to, for example, a request from mobile object 2 for remote operation or when determining that mobile object 2 should be remotely operated.

Information processing system 1 is an example of the computer that executes the information processing method. The elements included in information processing system 1 may be provided in a single housing or may be disposed in a distributed manner. When the elements included in information processing system 1 are disposed in a distributed manner, the information processing method may be executed by a plurality of computers. In the embodiment, information processing system 1 is realized in the form of a server device.

As shown in FIG. 1, mobile object 2 includes communicator 21, position obtainer 22, route obtainer 23, state obtainer 24, video obtainer 25, processing unit 26, remote operation controller 27, and autonomous driving controller 28. Communicator 21, position obtainer 22, route obtainer 23, state obtainer 24, video obtainer 25, processing unit 26, remote operation controller 27, and autonomous driving controller 28 are realized, for example, by means of a processor executing a program stored in memory and a communication interface. The memory is, for example, a read-only memory (ROM) and a random access memory (RAM), and is capable of storing the program executed by the processor.

Communicator 21 is, for example, a wireless communication interface for communicating with information processing system 1 via network N1 such as the Internet. Communicator 21 transmits, to information processing system 1, position information related to the position of mobile object 2 obtained by position obtainer 22, route information related to at least one of the movement route or the movement range of mobile object 2 obtained by route obtainer 23, and state information related to the state of mobile object 2 obtained by state obtainer 24. Communicator 21 also transmits, to information processing system 1, video information which is obtained by video obtainer 25 and related to video of an area in the vicinity of mobile object 2 captured by a camera included in mobile object 2. Also, communicator 21 receives, for example, an instruction signal, transmitted from the remote control system, indicating an instruction for remote control of mobile object 2.

Position obtainer 22 detects the position of mobile object 2, thereby obtaining information indicating the position of such mobile object 2. Position obtainer 22 detects the position of mobile object 2 on the basis of the positioning results of a positioning system such as a global positioning system (GPS).

Route obtainer 23 obtains the route information related to at least one of the movement route or the movement range of mobile object 2. The movement route indicates the route along which mobile object 2 moves within the facility or the site. The movement range indicates the range in which mobile object 2 moves within the facility or the site. Route obtainer 23 reads out the route information stored in the memory, for example, thereby obtaining the route information.

State obtainer 24 obtains the state information related to the state of mobile object 2. The state information can include, for example, information indicating whether mobile object 2 is autonomously moving, information indicating whether mobile object 2 is being remotely operated by an operator, or information indicating whether mobile object 2 is in standby state. The state information can also include, for example, information indicating whether a malfunction has occurred in mobile object 2, or information indicating whether mobile object 2 is stuck. State obtainer 24 requests processing unit 26 for obtaining the state of mobile object 2, for example, thereby obtaining the state information.

Video obtainer 25 obtains the video information related to video of an area in the vicinity of mobile object 2 captured by the camera included in mobile object 2. The video information can include, for example, video capturing a front area of mobile object 2, video capturing a leftward area of mobile object 2, video capturing a rightward area of mobile object 2, and video capturing a rearward area of mobile object 2. Note that the video information is not required to include all of these videos, and may include, for example, only the video capturing the forward area of mobile object 2.

Processing unit 26 is the main controller of mobile object 2. Processing unit 26 performs overall management and control of mobile object 2 by cooperating with each of communicator 21, position obtainer 22, route obtainer 23, state obtainer 24, video obtainer 25, remote operation controller 27, and autonomous driving controller 28.

Remote operation controller 27 causes mobile object 2 to move by controlling mobile object 2 in accordance with the details of an instruction provided to mobile object 2 from the remote control system via network N1. Through this, mobile object 2 is remotely operated in accordance with the instruction of an operator.

Autonomous driving controller 28 causes mobile object 2 to autonomously move, by controlling mobile object 2 in accordance with the details of an instruction provided to mobile object 2 from the remote control system via network N1. The instruction here is different from the instruction from the operator just described above. When mobile object 2 is an automatic monitoring robot, for example, autonomous driving controller 28 causes mobile object 2 to autonomously move, in accordance with the instruction indicating that mobile object 2 should move to one or more patrol destinations.

As shown in FIG. 1, information processing system 1 includes communicator (outputter) 11, obtainer 12, and processing unit 13. Communicator 11, obtainer 12, and processing unit 13 are realized, for example, by means of a processor executing a program stored in memory and a communication interface. The memory is, for example, a ROM and a RAM, and is capable of storing the program executed by the processor. Also, information processing system 1 communicates with storage device 4 via network N1, thereby reading information stored in storage device 4 to refer to such information. Note that storage device 4 may be included in the same server device as that of information processing system 1.

Communicator 11 is a wireless communication interface for communicating, via network N1, with each of one or more mobile objects 2 subjected to processing performed by information processing system 1. Communicator 11 receives, for each mobile object 2, the position information, the route information, the state information, and the video information transmitted from mobile object 2. Note that although FIG. 1 shows only one mobile object 2, a plurality of mobile objects 2 are present in the embodiment.

Communicator 11 also communicates with information terminal 3 used by an operator, via network N1. Information terminal 3 is, for example, a terminal such as a smartphone, a tablet terminal, or a personal computer. The following description assumes that information terminal 3 is a personal computer. FIG. 1 shows only one information terminal 3, but when a plurality of operators are present, for example, a plurality of information terminals 3 used by the respective operators are present. In this case, communicator 11 communicates with each of the plurality of information terminals 3.

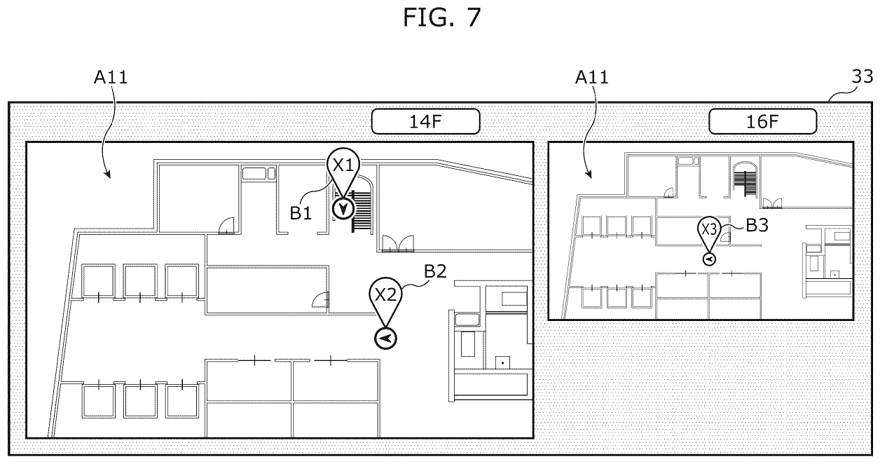

In the embodiment, communicator 11 transmits information related to mobile object 2 to information terminal 3 via network N1, which is, in particular, second information related to each of the one or more first regions A11 (see, for example, FIG. 7) where one or more mobile objects 2 are present. First region A11 and the second information are described later. Stated differently, communicator 11 also serves as an outputter that outputs the second information.

Here, as shown in FIG. 1, information terminal 3 includes communicator 31, terminal processing unit 32, and display 33. Communicator 31 and terminal processing unit 32 are realized, for example, by means of a processor executing a program stored in memory and a communication interface. The memory is, for example, a ROM and a RAM, and is capable of storing the program executed by the processor.

Communicator 31 is a wireless communication interface for communicating with information processing system 1 via network N1. Communicator 31 receives information related to mobile object 2 transmitted from information processing system 1, which is, in particular, the second information.

Terminal processing unit 32 is the main controller of information terminal 3. Terminal processing unit 32 performs overall management and control of information terminal 3 by cooperating with each of communicator 31 and display 33.

Display 33 is, for example, a liquid crystal display, and shows information processed by terminal processing unit 32. In the embodiment, display 33 mainly shows the second information. Specific forms of the information shown on display 33 are described in detail in [2. Operation].

Returning to the description of information processing system 1, obtainer 12 obtains various information via communicator 11 and network N1. More specifically, obtainer 12 obtains first information related to a region where each of the one or more mobile objects 2 is present. The first information can include, for example, an area identifier indicating region A1 where each of the one or mobile objects 2 is present, out of the position information obtained from each mobile object 2. The first information can also include, for example, information indicating the position of each of the one or more mobile objects 2, out of the position information obtained from each mobile object 2.

Obtainer 12 also obtains information related to each of the one or more mobile objects 2 from area information database (DB) 41, intervention information DB 42, notification information DB 43, and traffic information DB 44 of storage device 4 to be described later.

Obtainer 12 also obtains the state information, the route information, and the video information from each of the one or more mobile objects 2. Note that, of the state information, it is possible to obtain, from the remote control system, information related to an anomaly in communication, such as a an interruption of communication between the remote control system and mobile object 2. Also, the information related to an anomaly in communication may be obtained from mobile object 2, when the communication is in such a state, for example, that communication between information processing system 1 and mobile object 2 is possible but a remote operation of mobile object 2 by an operator is impossible.

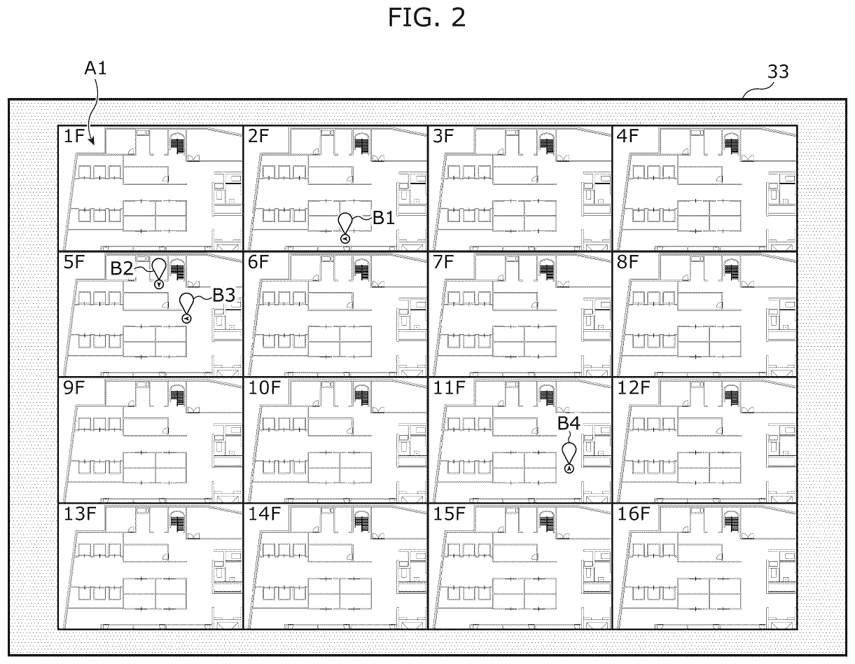

Processing unit 13 is the main controller of information processing system 1. Processing unit 13 performs overall management and control of information processing system 1 by cooperating with each of communicator 11 and obtainer 12. Processing unit 13 extracts one or more first regions A11 where one or more mobile objects 2 are present, from among a plurality of regions A1 (see, for example, FIG. 2), on the basis of the first information obtained by obtainer 12. Here, the plurality of regions A1 correspond to, for example, a plurality of floors in the case of a facility. The plurality of regions A1 also correspond to, for example, a plurality of divided regions into which the site is divided at a certain range. Note that, even in the case of a facility, for example, the plurality of regions A1 may include a plurality of divided regions into which a single floor is divided at a certain range.

With reference to FIG. 2, the following describes the reason that processing unit 13 extracts one or more first regions A11 from the plurality of regions A1. FIG. 2 is a diagram for describing a problem. FIG. 2 shows an example of information shown on display 33 of information terminal 3. FIG. 2 shows an example case where four mobile objects 2 are used in a 16-story building. For this reason, display 33 shows maps of the 1st to 16th floors all at once as the plurality of regions A1.

In the example shown in FIG. 2, the positions of four mobile objects 2 are represented by marks B1, B2, B3, and B4. Here, one mobile object 2 is present on the 2nd floor, two on the 5th floor, and one on the 11th floor. Since display 33 shows the maps of all the floors all at once, display 33 shows a small amount of information on each floor. This makes it difficult for an operator (user) to grasp the situation of each mobile object 2 even by looking at display 33. This problem becomes more pronounced as the number of regions A1 increases.

In view of this, processing unit 13 of information processing system 1 according to the embodiment extracts, from the plurality of regions A1, one or more first regions A11 where one or more mobile objects 2 are present. In the example shown in FIG. 2, processing unit 13 extracts the 2nd floor, the 5th floor, and the 11th floor as the one or more first regions A11. Then, by displaying, onto display 33, only the second information related to each of the one or more first regions A11 extracted, that is, the maps of the 2nd floor, the fifth floor, and the 11th floor in this case, an increased amount of information related to each floor will be shown on display 33. This enables the operator (user) to more easily grasp the situation of each mobile object 2 by looking at display 33.

More specifically, processing unit 13 includes display area determiner 131, belonging area determiner 132, inter-area movement determiner 133, and priority determiner 134. Processing unit 13 extracts at least one or more first regions A11 in accordance with determinations performed by these elements. All of display area determiner 131, belonging area determiner 132, inter-area movement determiner 133, and priority determiner 134 are realized in the form of functions executed by processing unit 13.

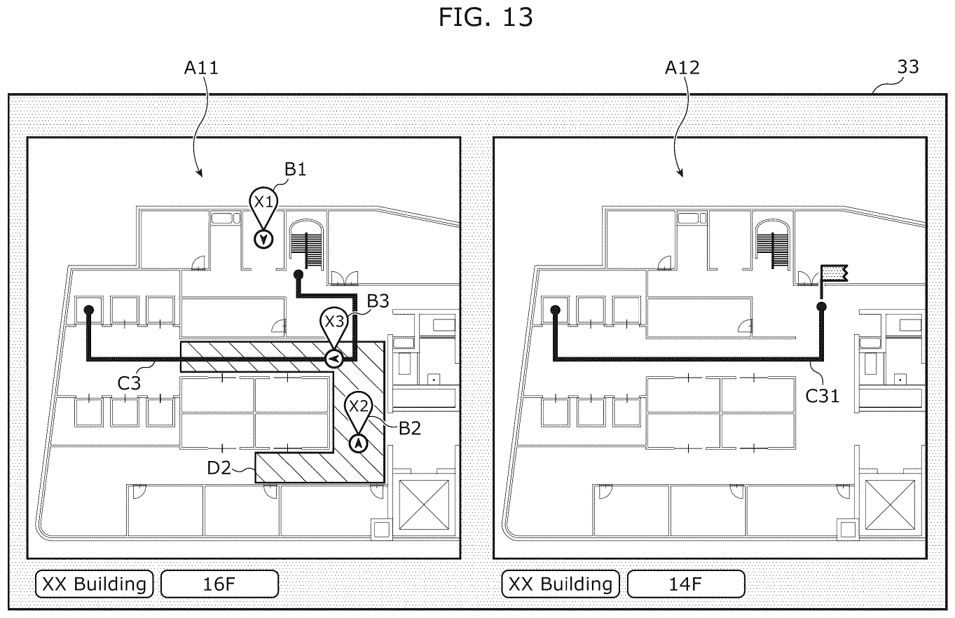

Display area determiner 131 determines one or more areas (one or more first regions A11) that should be shown on display 33 of information terminal 3, from among the plurality of regions A1, on the basis of the first information obtained by obtainer 12. Display area determiner 131 also determines one or more areas (one or more second regions A12 (see, for example, FIG. 13)) that should be shown on display 33 of information terminal 3, on the basis of the route information obtained by obtainer 12. The operation performed by display area determiner 131 is described in detail in [2. Operation].

Belonging area determiner 132 determines region A1 to which each of the one or more mobile objects 2 belongs (is present), on the basis of the first information obtained by obtainer 12. The function of belonging area determiner 132 is activated when the first information does not include an area identifier. The operation performed by belonging area determiner 132 is described in detail in [2. Operation].

Inter-area movement determiner 133 determines whether mobile object 2 will move across a plurality of areas, on the basis of the route information obtained by obtainer 12. The operation performed by inter-area movement determiner 133 is described in detail in [2. Operation].

Priority determiner 134 determines an area to be preferentially shown on display 33, among the one or more areas (one or more first regions A11, and if present, one or more second regions A12) that should be shown on display 33, on the basis of the various information obtained by obtainer 12. The operation performed by priority determiner 134 is described in detail in [2. Operation].

Storage device 4 stores area information DB 41, intervention information DB 42, notification information DB 43, and traffic information DB 44.

Area information DB 41 stores area information related to each of the plurality of regions A1. Area information DB 41 stores, for each area, the area information including, for example, the area identifier, the area name, the save location of a map image (floor map) of the area, and the area range. The area information is stored into area information DB 41 by, for example, obtaining information entered by an operator using information terminal 3.

Intervention information DB 42 stores intervention information indicating that there has been an intervention by an operator who is remotely monitoring one or more mobile objects 2. Here, the operator intervention can include, for example, the case where the operator remotely operates mobile object 2 when such mobile object 2 is in a situation where mobile object 2 is difficult to autonomously move. The operator intervention can also include the case where response personnel will be dispatched to mobile object 2 to improve the situation, when, for example, remote operation of such mobile object 2 becomes difficult. The intervention information is stored into intervention information DB 42, by, for example, obtaining information entered by the operator using information terminal 3.

Notification information DB 43 stores notification information indicating that an operator who is remotely monitoring one or more mobile objects 2 has received a notification from such one or more mobile objects 2. Here, the notification to the operator can be provided, for example, when mobile object 2 falls in a situation that should be reported to the operator, such as a situation where autonomous movement of mobile object 2 is difficult. The notification information is stored into notification information DB 43, by, for example, obtaining information transmitted from each of the one or more mobile objects 2.

Traffic information DB 44 stores traffic information related to the traffic in each of the one or more first regions A11. Here, traffic includes, for example, the movement of persons or vehicles in the vicinity of mobile object 2 that could interfere with the execution of the task by mobile object 2 in first region A11. The traffic information is stored into traffic information DB 44 by, for example, obtaining information transmitted from each of the one or more mobile objects 2. The traffic information is also stored into traffic information DB 44 by, for example, obtaining information entered by an operator using information terminal 3.

### [2. Operation]

The following describes the operation performed by information processing system 1 according to the embodiment.

### [2-1. Basic Operation]

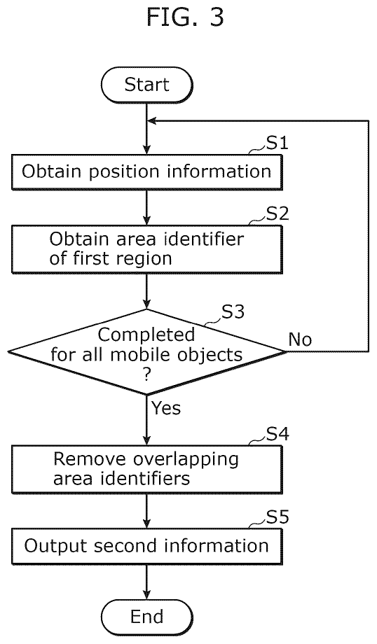

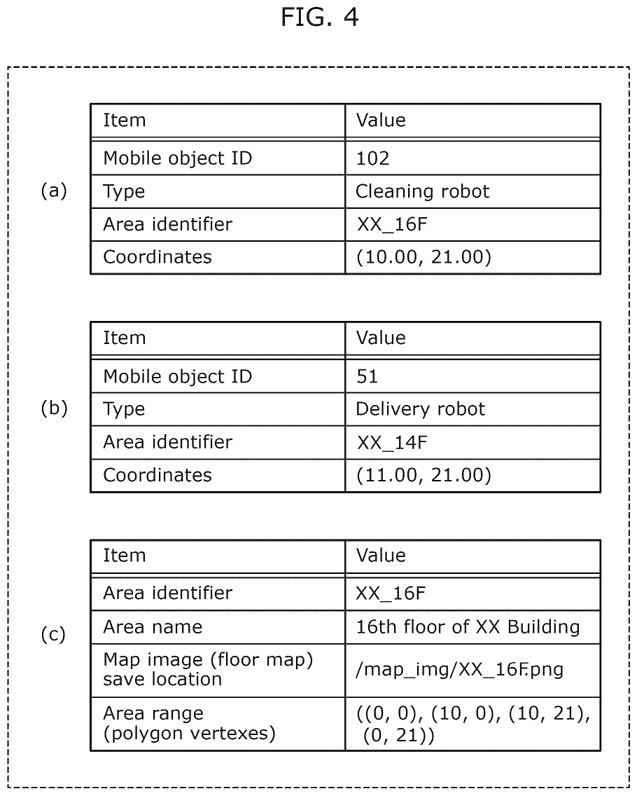

First, with reference to FIG. 3 and FIG. 4, the basic operation performed by information processing system 1 is described. FIG. 3 is a flowchart showing an example of the basic operation performed by information processing system 1 according to the embodiment. FIG. 4 is a diagram showing examples of the position information and the area information.

Each of (a) and (b) in FIG. 4 shows an example of the position information. (c) in FIG. 4 shows an example of the area information. In each of (a) and (b) in FIG. 4, “mobile object ID” indicates the identifier assigned to mobile object 2, “type” indicates the task executed by mobile object 2, “area identifier” indicates the identifier of the area where mobile object 2 is present, and “coordinates” indicates the xy coordinates of the current position of mobile object 2 detected by mobile object 2. (a) in FIG. 4 shows the position information of mobile object 2 to which mobile object ID “102” is assigned, and (b) in FIG. 4 shows the position information of mobile object 2 to which mobile object ID “51” is assigned. In (c) in FIG. 4, “area identifier” indicates the identifier of the area, “area name” indicates the name of the area, “map image (floor map) save location” indicates the address at which the map image of the area is stored in area information DB 41, and “area range” indicates the xy coordinates of each polygon vertex that defines the range of the area.

First, obtainer 12 obtains the position information from one of mobile objects 2 (S1). Next, display area determiner 131 of processing unit 13 obtains, as the area identifier of first region A11, the area identifier included in the position information obtained by obtainer 12 (S2). Thereafter, steps S1 and S2 are repeated until the processes are completed for all mobile objects 2 (S3: No).

When the processes are completed for all mobile objects 2 (S3: Yes), display area determiner 131 removes overlapping area identifiers from the area identifiers of the one or more first regions A11 that have been obtained (S4). Through this, it is possible for display area determiner 131 to extract one or more first regions A11 from the plurality of regions A1.

Communicator (outputter) 11 then outputs one or more items of area information (second information) corresponding one-to-one to the one or more area identifiers extracted by display area determiner 131 (S5). In the embodiment, communicator 11 outputs the second information by reading, from area information DB 41, the one or more items of area information corresponding one-to-one to the one or more area identifiers, and then by transmitting, to information terminal 3, the one or more items of area information having been read. Thereafter, the foregoing steps S1 to S5 are repeated while information processing system 1 is in operation.

When the position information as shown in each of (a) and (b) in FIG. 4 is obtained, for example, display area determiner 131 extracts the 14th floor and the 16th floor (one or more first regions A11) from the 1st to 16th floors (the plurality of regions A1). Communicator (outputter) 11 then transmits, to information terminal 3, the area information of the 14th floor and the area information of the 16th floor (second information) corresponding to the area identifier of the 14th floor and the area identifier of the 16th floor, respectively, that have been extracted by display area determiner 131.

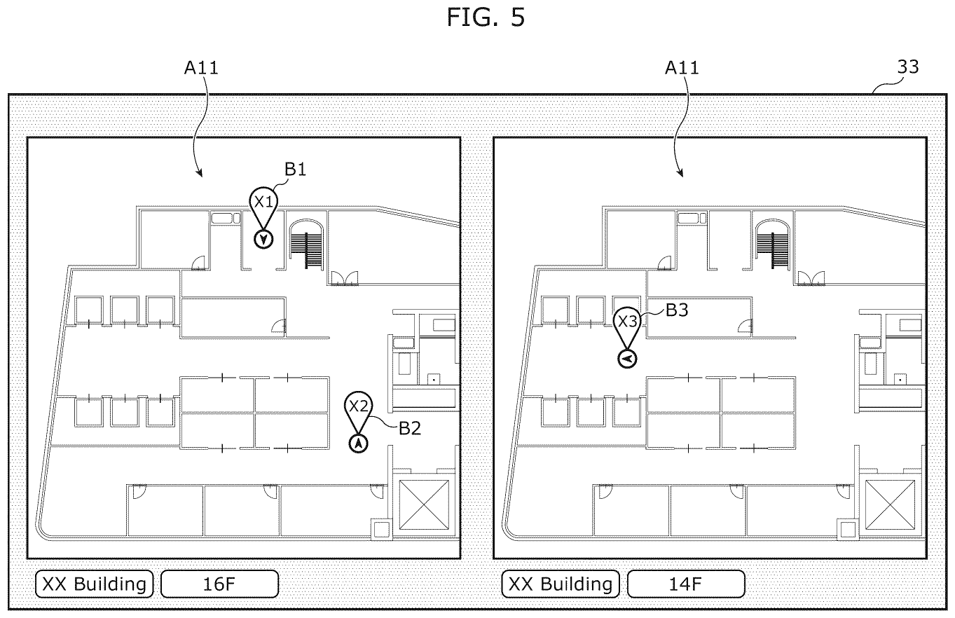

FIG. 5 is a diagram showing Display Example 1 in the example of the basic operation. FIG. 5 shows an example of the second information shown on display 33 of information terminal 3. In the example shown in FIG. 5, the second information includes the area information of the 14th floor and the area information of the 16th floor in “XX Building”. Display 33 thus shows the map of the 14th floor and the map of the 16th floor in “XX Building”. Display 33 also shows mark B1 representing the position of mobile object 2 with mobile object ID “X1”, mark B2 representing the position of mobile object 2 with mobile object ID “X2”, and mark B3 representing the position of mobile object 2 with mobile object ID “X3”. As described above, the second information includes at least one of the information indicating the map of each of the one or more first regions A11 or the information indicating the position of each of the one or more mobile objects 2 in the one or more first regions A11 (in this case, both of these items of information).

By looking at display 33, it is possible for an operator (user) to easily grasp that two mobile objects 2 with mobile object IDs “X1” and “X2” are present on the 16th floor, and that one mobile object 2 with mobile object ID “X3” is present on the 14th floor.

The following recites Display Example 2 to Display Example 4, which are display examples other than Display Example 1 in the example of the basic operation. Information processing system 1 is capable of causing display 33 of information terminal 3 to show the second information in one of the display forms among Display Example 1 to Display Example 4. Note that information processing system 1 may also cause display 33 to show the second information in a display form other than those of Display Example 1 to Display Example 4.

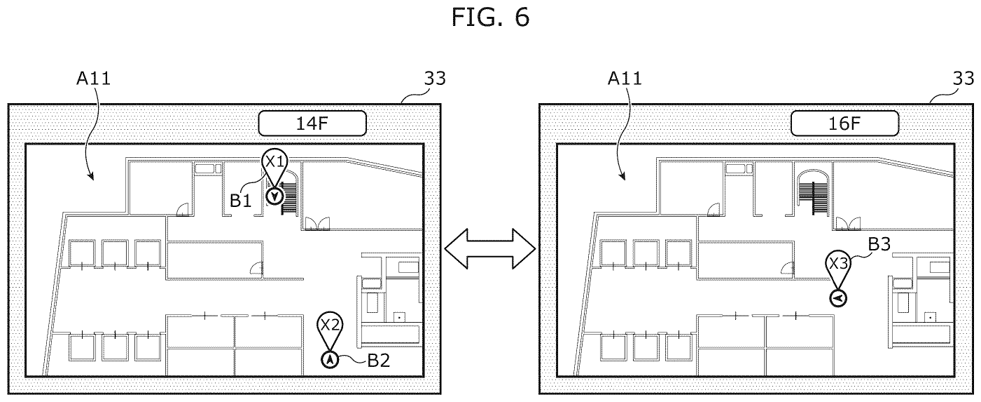

FIG. 6 is a diagram showing Display Example 2 in the example of the basic operation. In Display Example 2, unlike Display Example 1, display 33 of information terminal 3 shows only information related to one first region A11. In Display Example 2, items of information related to first regions A11 shown on display 33 are switched every fixed time period (e.g., every tens of seconds). In the example shown in FIG. 6, display 33 alternately shows the area information of the 14th floor and the area information of the 16th floor in “XX Building” every fixed time period.

FIG. 7 is a diagram showing Display Example 3 in the example of the basic operation. In Display Example 3, unlike Display Example 1, display 33 of information terminal 3 shows, in a larger size, first region A11 where a larger number of mobile objects 2 is present. In the example shown in FIG. 7, the map of the 14th floor in “XX Building”, where two mobile objects 2 are present, is shown in a larger size than the map of the 16th floor, where only one mobile object 2 is present.

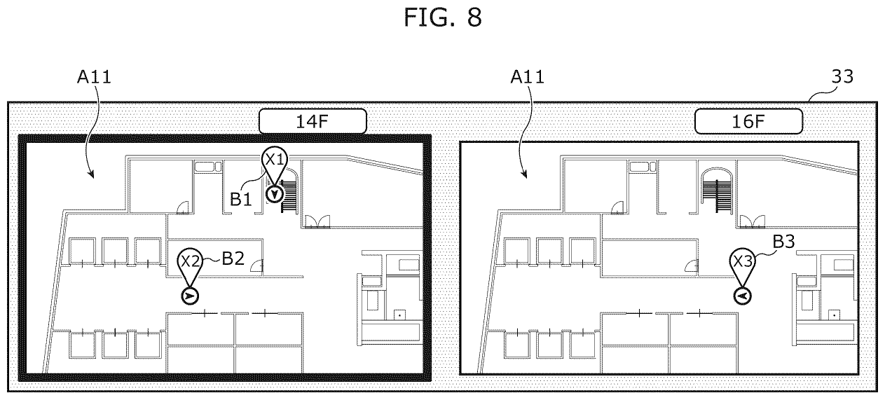

FIG. 8 is a diagram showing Display Example 4 in the example of the basic operation. In Display Example 4, unlike Display Example 1, display 33 of information terminal 3 shows, in an emphasized manner, first region A11 where a larger number of mobile objects 2 is present. In the example shown in FIG. 8, the map of the 14th floor in “XX Building,” where two mobile objects 2 are present, is surrounded by a bold frame to be shown in an emphasized manner, compared to the map of the 16th floor, where only one mobile object 2 is present.

### [2-2. Working Example 1]

The following describes Working Example 1 that can be executed by information processing system 1. Working Example 1 is executed when the position information obtained from each of the one or more mobile objects 2 does not include the area identifier. More specifically, processing unit 13 extracts one or more first regions A11 on the basis of the information, obtained by obtainer 12, indicating the position of each of the one or more mobile objects 2.

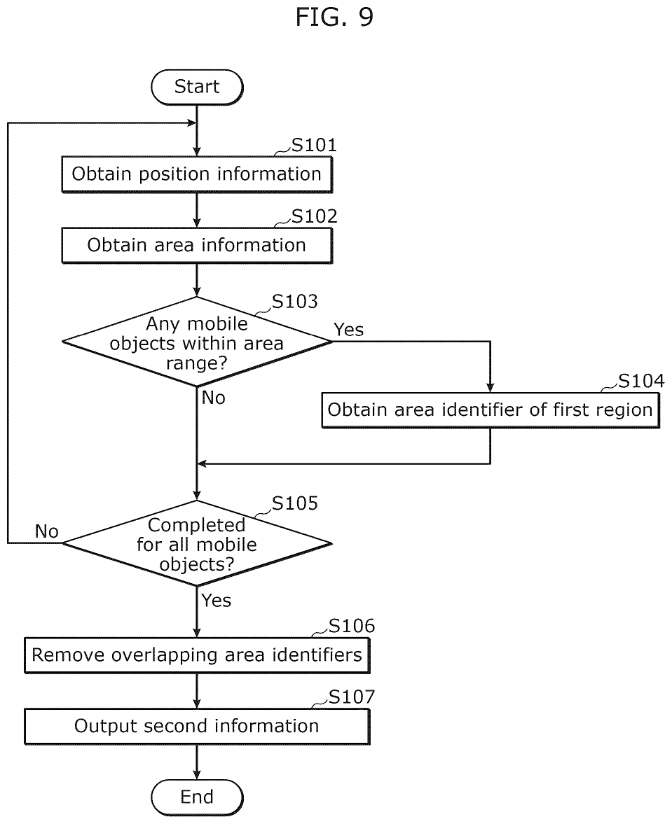

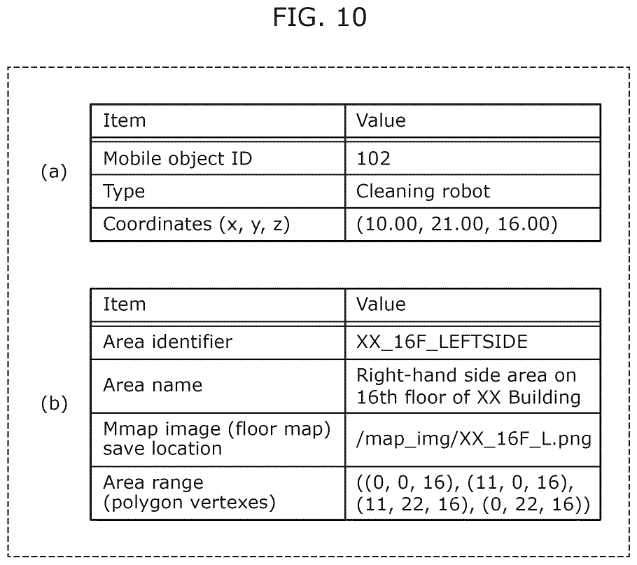

The following describes Working Example 1 in detail. The following omits detailed descriptions for the points that are common with those of the example of the basic operation. FIG. 9 is a flowchart showing Working Example 1 of information processing system 1 according to the embodiment. FIG. 10 is a diagram showing other examples of the position information and the area information.

(a) in FIG. 10 shows another example of the position information. (b) in FIG. 10 shows another example of the area information. In Working Example 1, unlike (a) in FIG. 4, the position information does not include the area identifier, as shown in (a) in FIG. 10. On the other hands, in Working Example 1, the coordinates of the current position of mobile object 2 included in the position information are represented by xyz coordinates. In such coordinates, the z-coordinate represents the height at which mobile object 2 is located. Here, the numerical value of the z-coordinate represents a floor number.

First, obtainer 12 obtains the position information from one of mobile objects 2 (S101). Next, obtainer 12 obtains the area information from area information DB 41 (S102). Belonging area determiner 132 of processing unit 13 then compares the position information and the area information to determine whether mobile object 2 is present within the area range (S103). More specifically, belonging area determiner 132 determines, for each area, whether the coordinates of the current position of mobile object 2 included in the position information are included within the area range included in the area information.

When determining that mobile object 2 is present within the area range (S103: Yes), display area determiner 131 obtains the area identifier of such area as the area identifier of first region A11 (S104). Meanwhile, when determining that no mobile object 2 is present within the area range (S103: No), display area determiner 131 does not obtain the area identifier of such area as the area identifier of first region A11. Thereafter, belonging area determiner 132 determines, for each of all the areas, whether mobile object 2 is present. Thereafter, steps S101 to S104 are repeated until the foregoing processes are completed for all mobile objects 2 (S105: No).

When the processes are completed for all mobile objects 2 (S105: Yes), display area determiner 131 removes overlapping area identifiers from the area identifiers of the one or more first regions A11 that have been obtained (S106). Communicator (outputter) 11 then outputs one or more items of area information (second information) corresponding one-to-one to the one or more area identifiers extracted by display area determiner 131 (S107). Thereafter, the foregoing steps S101 to S107 are repeated while information processing system 1 is in operation.

### [2-3. Working Example 2]

The following describes Working Example 2 that can be executed by information processing system 1. Working Example 2 is executed when route information is further obtained from each of the one or more mobile objects 2. More specifically, processing unit 13 extracts, from the plurality of regions A1, one or more second regions A12 (see, for example, FIG. 13) where one or more mobile objects 2 were present before the point in time when the first information was obtained or where one or more mobile objects 2 can be present after the point in time when the first information is obtained, on the basis of the route information obtained by obtainer 12. Then, communicator (outputter) 11 further outputs third information related to the one or more second regions A12 that have been extracted.

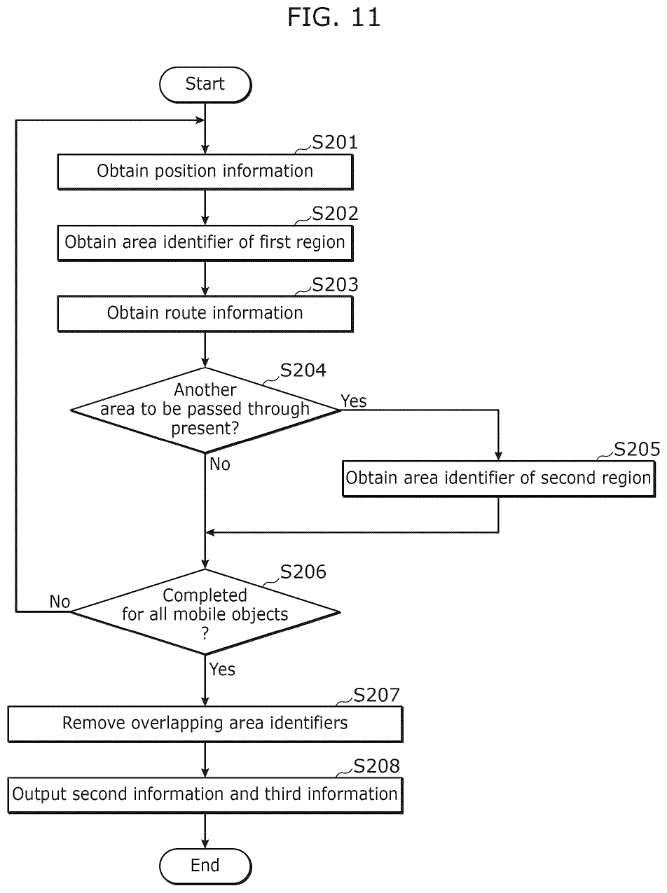

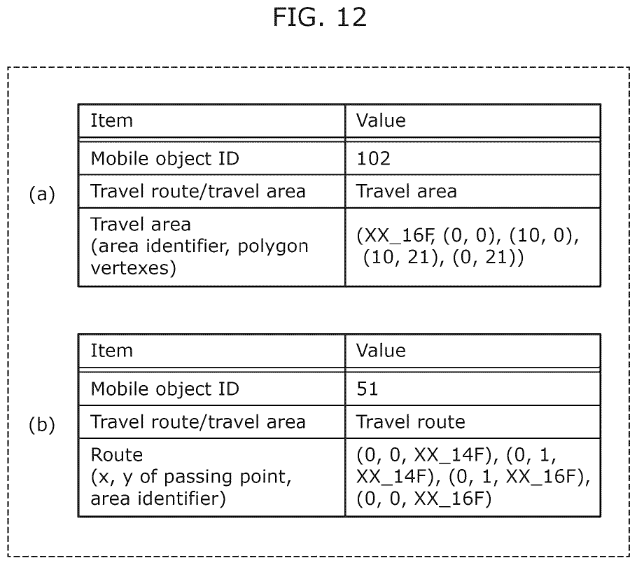

The following describes Working Example 2 in detail. The following omits detailed descriptions for the points that are common with those of the example of the basic operation. FIG. 11 is a flowchart showing Working Example 2 of information processing system 1 according to the embodiment. FIG. 12 is a diagram showing examples of the route information.

Each of (a) and (b) in FIG. 12 shows an example of the route information. In each of (a) and (b) in FIG. 12, “mobile object ID” indicates the identifier assigned to mobile object 2, and “travel route/travel area” indicates the type of the route information of mobile object 2. In (a) in FIG. 12, “travel area” is information that defines the travel area (movement range) of mobile object 2, and includes the area identifier indicating the area in which mobile object 2 travels, and the xy coordinates of each polygon vertex that defines the area range. In (b) in FIG. 12, “route” is information that defines the travel route (movement route) of mobile object 2, and includes the xy coordinates of passing points through which mobile object 2 passes and the area identifiers. (a) in FIG. 12 shows the route information of mobile object 2 to which mobile object ID “102” is assigned, and (b) in FIG. 12 shows the route information of mobile object 2 to which mobile object ID “51” is assigned.

First, obtainer 12 obtains the position information from one of mobile objects 2 (S201). Next, display area determiner 131 of processing unit 13 obtains, as the area identifier of first region A11, the area identifier included in the position information obtained by obtainer 12 (S202).

Next, obtainer 12 obtains the route information from the same mobile object 2 as mobile object 2 described above (S203). Display area determiner 131 of processing unit 13 then determines whether another area to be passed through is present (S204). More specifically, display area determiner 131 determines whether the area identifier included in the route information obtained by obtainer 12 includes an area identifier different from the area identifier of first region A11.

When another area to be passed through is present (S204: Yes), display area determiner 131 obtains an area identifier different from the area identifier of first region A11 as the area identifier of second region A12 (S205). Meanwhile, when no other areas to be passed through are present (S204: No), display area determiner 131 does not obtain the area identifier of second region A12. Thereafter, step S201 to step S205 are repeated until the foregoing processes are completed for all mobile objects 2 (S206: No).

When the processes are completed for all mobile objects 2 (S206: Yes), display area determiner 131 removes overlapping area identifiers from the area identifiers of the one or more first regions A11 and the area identifiers of the one or more second regions A12 that have been obtained (S207). Through this, it is possible for display area determiner 131 to extract one or more first regions A11 and one or more second regions A12 from the plurality of regions A1.

Communicator (outputter) 11 then outputs: one or more items of area information (second information) corresponding one-to-one to the area identifiers of the one or more first regions A11 extracted by display area determiner 131; and one or more items of area information (third information) corresponding one-to-one to the area identifiers of the one or more second regions A12 extracted by display area determiner 131 (S208). Thereafter, the foregoing steps S201 to S208 are repeated while information processing system 1 is in operation.

When the route information shown in each of (a) and (b) in FIG. 12 is obtained, for example, the current position of mobile object 2 to which mobile object ID “51” is assigned is the 14th floor (see (b) in FIG. 4), but the passing points include the 16th floor. For this reason, display area determiner 131 extracts the 16th floor (one or more second regions A12) from the 1st to 16th floors (the plurality of regions A1). Communicator (outputter) 11 then transmits, to information terminal 3, the area information of the 16th floor (third information) corresponding to the area identifier of the 16th floor extracted by display area determiner 131.

FIG. 13 is a diagram showing Display Example 1 in Working Example 2. FIG. 13 shows an example of each of the second information and the third information shown on display 33 of information terminal 3. In the example shown in FIG. 13, the second information includes the area information of the 16th floor in “XX Building”. Also, in the example shown in FIG. 13, the third information includes the area information of the 14th floor in “XX Building”. Display 33 thus shows the map of the 14th floor and the map of the 16th floor in “XX Building”. Display 33 also shows mark B1 representing the position of mobile object 2 with mobile object ID “X1”, mark B2 representing the position of mobile object 2 with mobile object ID “X2”, and mark B3 representing the position of mobile object 2 with mobile object ID “X3”.

Display 33 further shows movement route C3 of mobile object 2 with mobile object ID “X3” and movement range D2 of mobile object 2 with mobile object ID “X2”. Display 33 also shows future movement route C31 of mobile object 2 with mobile object ID “X3”. As described above, at least one of the second information or the third information (in this case, both) includes information indicating at least one of the movement route or the movement range (in this case, both) of each of the one or more mobile objects 2.

By looking at display 33, it is possible for an operator (user) to easily grasp that three mobile objects 2 with mobile object IDs “X3”, “X1”, and “X2 are present on the 16th floor. By looking at display 33, it is also possible for the operator to easily grasp that mobile object 2 with mobile object ID “X2” only moves on the 16th floor, and that mobile object 2 with mobile object ID “X3” moves on the 16th floor and then onto the 14th floor.

The following recites Display Example 2 to Display Example 5, which are display examples other than Display Example 1 in Working Example 2. Information processing system 1 is capable of causing display 33 of information terminal 3 to show the second information and the third information in one of the display forms among Display Example 1 to Display Example 5. Note that information processing system 1 may also cause display 33 to show the second information and the third information in a display form other than those of Display Example 1 to Display Example 5.

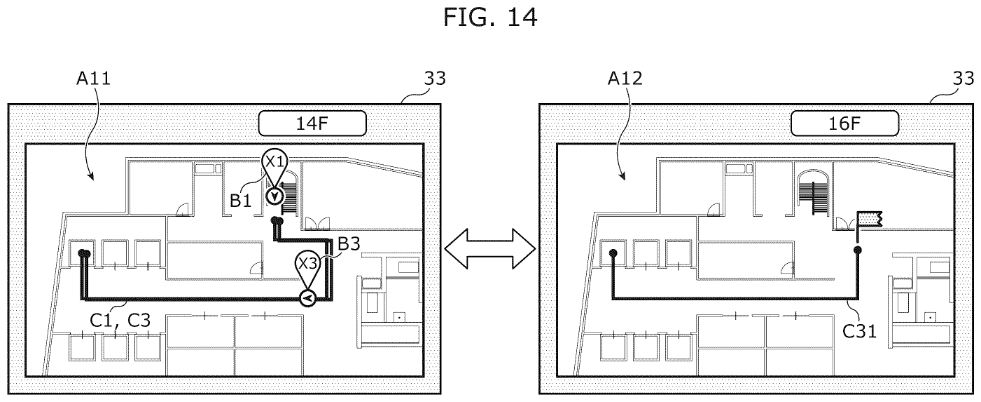

FIG. 14 is a diagram showing Display Example 2 in Working Example 2. In Display Example 2, unlike Display Example 1, display 33 of information terminal 3 shows only information related to one of first region A11 and second region A12. In Display Example 2, items of information related to regions to be shown on display 33 are switched every fixed time period (e.g., tens of seconds). In the example shown in FIG. 14, display 33 alternately shows the area information of the 14th floor and the area information of the 16th floor in “XX Building” every fixed time period.

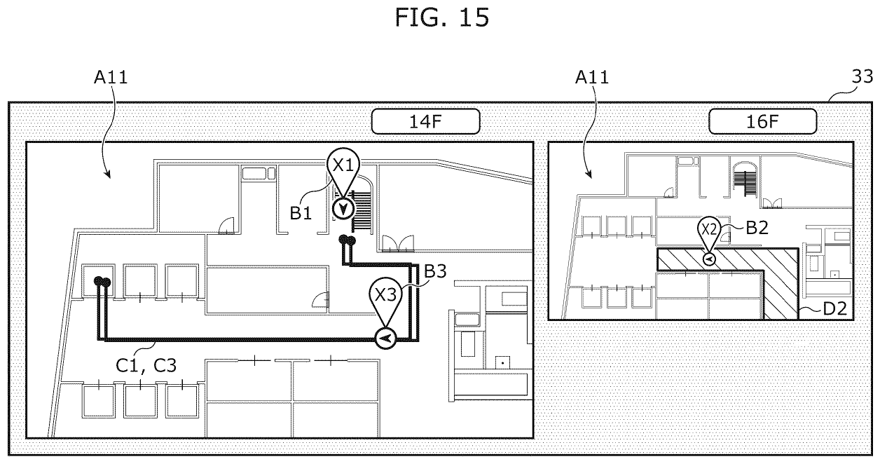

FIG. 15 is a diagram showing Display Example 3 in Working Example 2. In Display Example 3, unlike Display Example 1, display 33 of information terminal 3 shows, in a larger size, first region A11 where a larger number of mobile objects 2 is present. In the example shown in FIG. 15, the map of the 14th floor in “XX Building,” where two mobile objects 2 are present, is shown in a larger size than the map of the 16th floor, where only one mobile object 2 is present. Note that in Display Example 3, display 33 does not show second region A12, but display 33 may show second region A12.

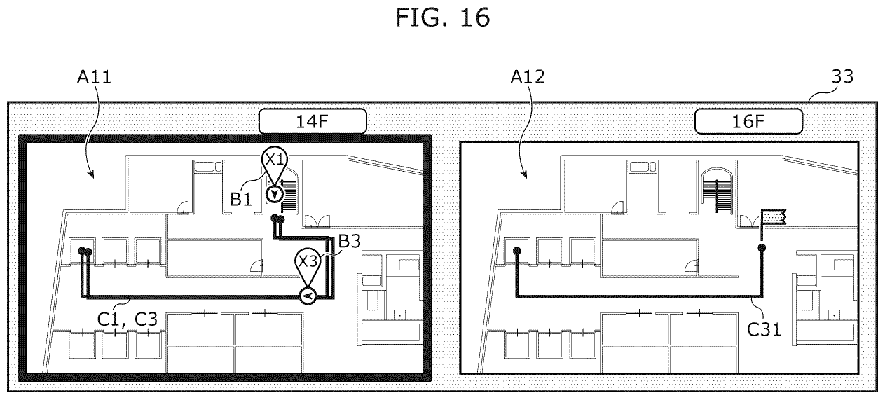

FIG. 16 is a diagram showing Display Example 4 in Working Example 2. In Display Example 4, unlike Display Example 1, display 33 of information terminal 3 shows first region A11 in an emphasized manner. In the example shown in FIG. 16, the map of the 14th floor in “XX Building,” which is first region A11, is surrounded by a bold frame to be shown in an emphasized manner, compared to the map of the 16th floor, which is second region A12.

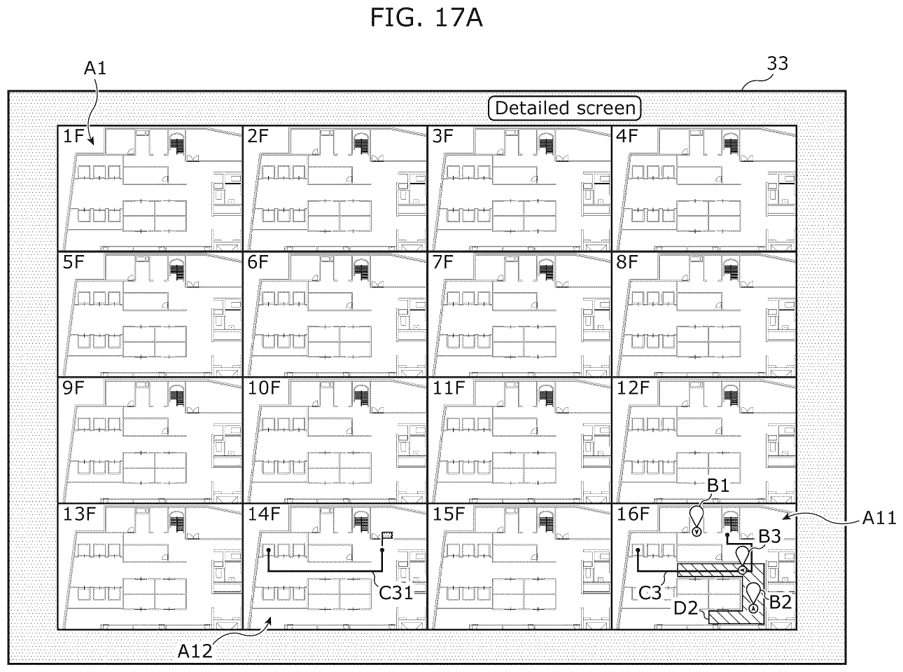

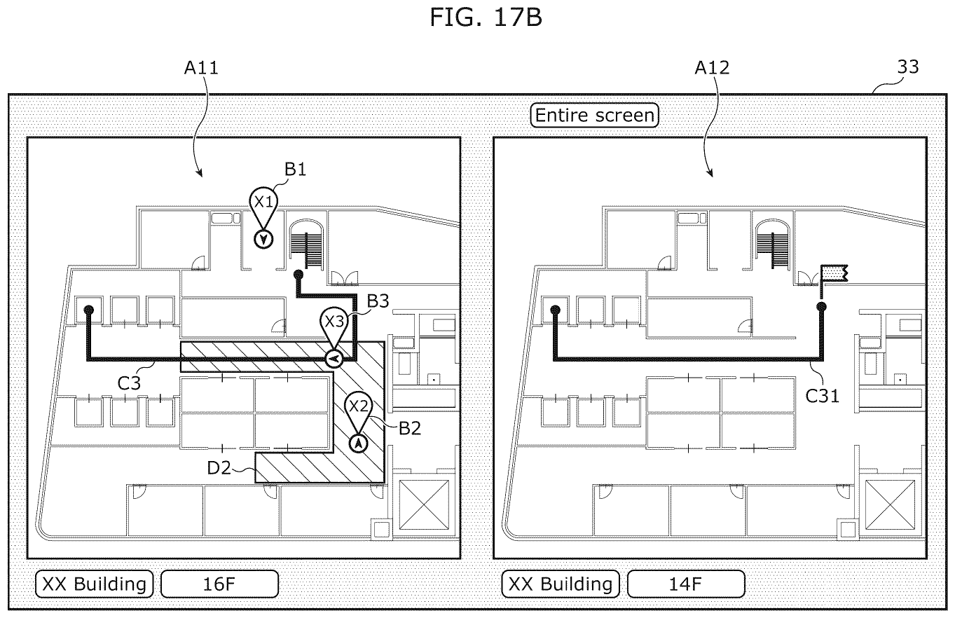

FIG. 17A and FIG. 17B are diagrams showing Display Example 5 in Working Example 2. FIG. 17A is a diagram showing an entire screen of Display Example 5 in Working Example 2, and FIG. 17B is a diagram showing a detailed screen of Display Example 5 in Working Example 2. In Display Example 5, it is possible to switch between causing display 33 to show the entire screen that shows all of the plurality of regions A1 or causing display 33 to show the detailed screen that shows only one or more first regions A11 and one or more second regions A12, in response to an operation performed by an operator (user) using information terminal 3. More specifically, when display 33 shows the entire screen, it is possible for the operator to switch to the detailed screen by selecting the “detailed screen” icon. Meanwhile, when display 33 shows the detailed screen, it is possible for the operator to switch to the entire screen by selecting the “entire screen” icon.

### [2-4. Working Example 3]

The following describes Working Example 3 that can be executed by information processing system 1. Working Example 3 is executed when state information is further obtained from each of the one or more mobile objects 2. More specifically, processing unit 13 extracts one or more first regions A11 on the basis of the state information obtained by obtainer 12.

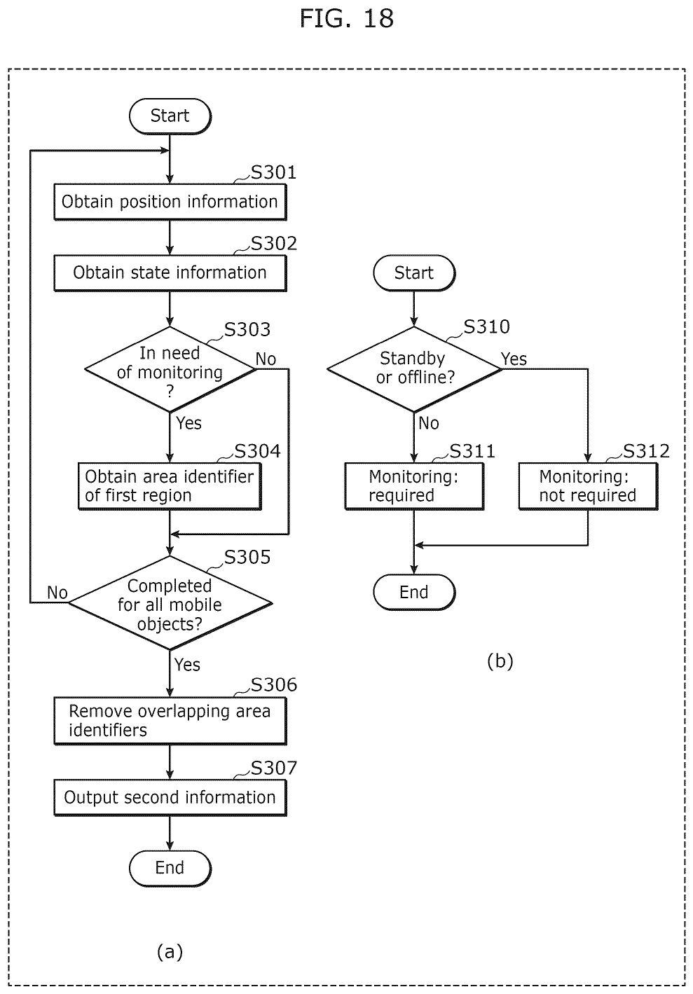

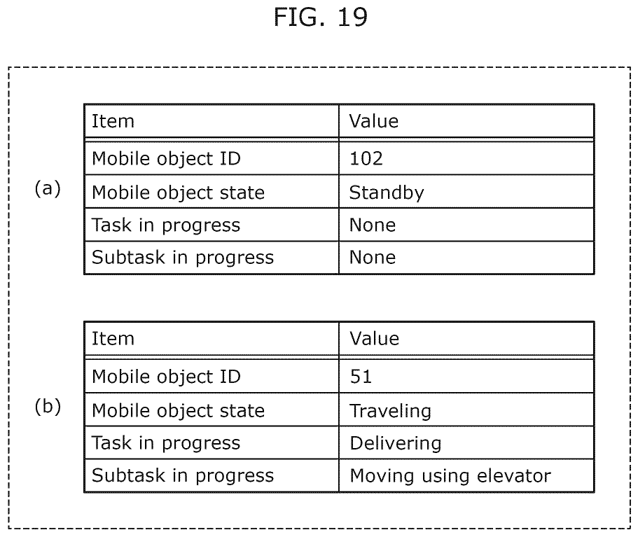

The following describes Working Example 3 in detail. The following omits detailed descriptions for the points that are common with those of the example of the basic operation. FIG. 18 is a flowchart showing Working Example 3 of information processing system 1 according to the embodiment. FIG. 19 is a diagram showing examples of the state information. (a) in FIG. 18 shows a whole overview of Working Example 3, and (b) in FIG. 18 shows an overview of the determination to be described later of whether mobile object 2 is in need of monitoring.

Each of (a) and (b) in FIG. 19 shows an example of the state information. In each of (a) and (b) in FIG. 19, “mobile object ID” indicates the identifier assigned to mobile object 2, and “mobile object state” indicates the state of mobile object 2. “Mobile object state” includes, for example, offline, standby, traveling, under remote operation, malfunction, safety stop, or proximity operation. In each of (a) and (b) in FIG. 19, “task in progress” indicates the task currently executed by mobile object 2, and “subtask in progress” indicates the details of the task currently executed by mobile object 2. “Task in progress” includes, for example, none, delivering, loading, unloading, returning, patrolling, or cleaning. Also, “subtask in progress” includes, for example, none, standby, moving, calling for an elevator, moving in an elevator, moving down in an elevator, waiting for an automatic door to open, passing through an automatic door, or waiting for another mobile object in proximity to pass. (a) in FIG. 19 shows the state information of mobile object 2 to which mobile object ID “102” is assigned, and (b) in FIG. 19 shows the state information of mobile object 2 to which mobile object ID “51” is assigned.

First, as shown in (a) in FIG. 18, obtainer 12 obtains the position information from one of mobile objects 2 (S301). Obtainer 12 also obtains the state information from the same mobile object 2 as mobile object 2 described above (S302). Display area determiner 131 of processing unit 13 then determines whether mobile object 2 is in need of monitoring (S303). More specifically, when “mobile object state” included in the state information obtained by obtainer 12 indicates standby or offline (S310: Yes) as shown in (b) in FIG. 18, display area determiner 131 determines that monitoring of mobile object 2 is not required (S312). Meanwhile, when “mobile object state” indicates neither standby nor offline (S310: No), display area determiner 131 determines that monitoring of mobile object 2 is required (S311).

With reference to (a) in FIG. 18 again, when mobile object 2 is in need of monitoring (S303: Yes), display area determiner 131 obtains, as the area identifier of first region A11, the area identifier included in the position information obtained by obtainer 12 (S304). Meanwhile, when mobile object 2 is not in need of monitoring (S303: No), display area determiner 131 does not obtain the area identifier of first region A11. Thereafter, step S301 to step S304 are repeated until the foregoing processes are completed for all mobile objects 2 (S305: No).

When the processes are completed for all mobile objects 2 (S305: Yes), display area determiner 131 removes overlapping area identifiers from the area identifiers of the one or more first regions A11 that have been obtained (S306). Communicator (outputter) 11 then outputs one or more items of area information (second information) corresponding one-to-one to the area identifiers of the one or more first regions A11 extracted by display area determiner 131 (S307). Thereafter, the foregoing steps S301 to S307 are repeated while information processing system 1 is in operation.

When the state information shown in each of (a) and (b) in FIG. 19 is obtained, for example, display area determiner 131 determines that mobile object 2 to which mobile object ID “102” is assigned is not in need of monitoring, since “mobile object state” of such mobile object 2 indicates standby. Meanwhile, display area determiner 131 determines that mobile object 2 to which mobile object ID “51” is assigned is in need of monitoring, since “mobile object state” of such mobile object 2 indicates traveling. For this reason, display area determiner 131 extracts the 16th floor (one or more first regions A11) from the 1st to 16th floors (the plurality of regions A1). Communicator (outputter) 11 then transmits, to information terminal 3, the area information (second information) of the 16th floor corresponding to the area identifier of the 16th floor extracted by display area determiner 131.

In Working Example 3, it is possible for an operator (user) to easily grasp a floor on which mobile object 2 in need of monitoring is present, by looking at display 33.

Note that, in Working Example 3, as with Working Example 2, information processing system 1 may extract one or more second regions A12 on the basis of the route information, and may further output the third information related to each of the one or more second regions A12 that have been extracted.

### [2-5. Working Example 4]

The following describes Working Example 4 that can be executed by information processing system 1. As with Working Example 2, Working Example 4 is executed when route information is further obtained from each of the one or more mobile objects 2. More specifically, processing unit 13 determines whether mobile object 2 will move between areas, on the basis of the route information obtained by obtainer 12. When mobile object 2 that will move between areas is present, communicator (outputter) 11 further outputs information indicating inter-area movement of such mobile object 2.

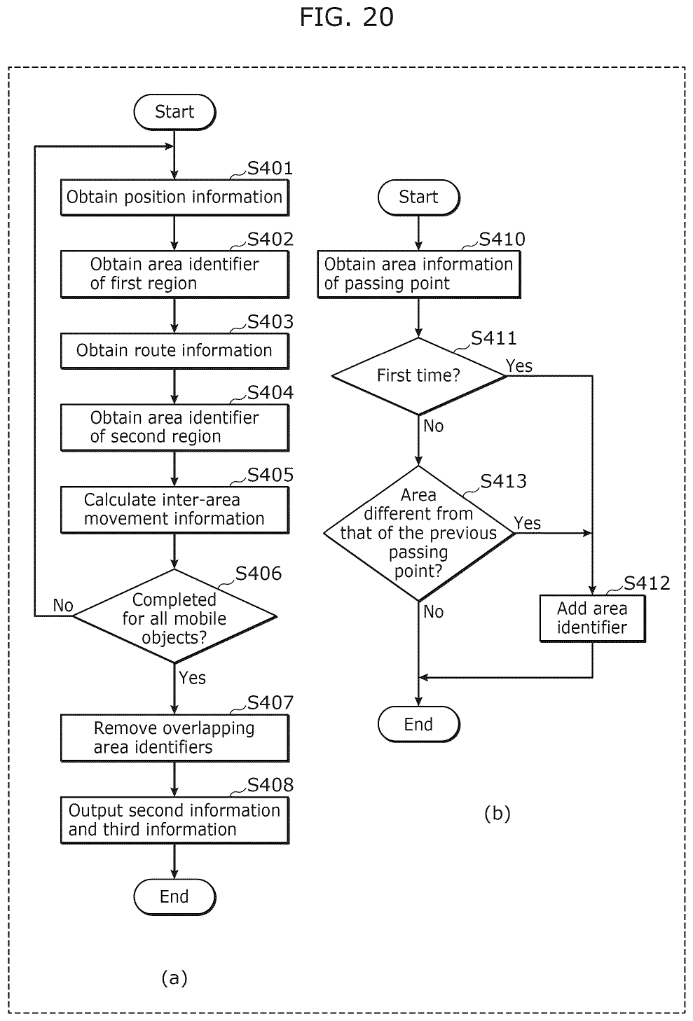

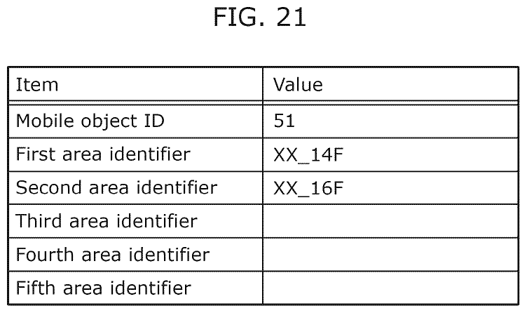

The following describes Working Example 4 in detail. The following omits detailed descriptions for the points that are common with those of Working Example 2. FIG. 20 is a flowchart showing Working Example 4 of information processing system 1 according to the embodiment. FIG. 21 is a diagram showing an example of inter-area movement information. (a) in FIG. 20 shows a whole overview of Working Example 4, and (b) in FIG. 20 shows an overview of the calculation to be described later of the inter-area movement information.

In FIG. 21, “mobile object ID” indicates the identifier assigned to mobile object 2, and “first area identifier” to “fifth area identifier” indicate the area identifiers of the areas through which mobile object 2 moves in order. The example shown in FIG. 21 indicates that “first area identifier” is “XX_14F” and “second area identifier” is “XX_16F”, which indicates that mobile object 2 will move from the 14th floor to the 16th floor in “XX Building”.

First, obtainer 12 obtains the position information from one of mobile objects 2 (S401). Next, display area determiner 131 of processing unit 13 obtains, as the area identifier of first region A11, the area identifier included in the position information obtained by obtainer 12 (S402).

Next, obtainer 12 obtains the route information from the same mobile object 2 as mobile object 2 described above (S403). Display area determiner 131 of processing unit 13 then determines whether another area to be passed through is present. The description here assumes that display area determiner 131 determines that another area to be passed through is present. Display area determiner 131 then obtains, as the area identifier of second region A12, an area identifier that is different from the area identifier of first region A11 (S404).

Next, inter-area movement determiner 133 determines whether mobile object 2 will move across a plurality of areas, on the basis of the route information obtained by obtainer 12, and calculates the inter-area movement information (S405). More specifically, as shown in (b) in FIG. 20, inter-area movement determiner 133 obtains the area information of the passing point from the route information (S410). Then, when it is the first time to obtain the area information of the passing point (S411: Yes), inter-area movement determiner 133 adds the area identifier corresponding to such area information (S412). Here, inter-area movement determiner 133 adds the area identifier corresponding to such area information as “first area identifier”. Next, when it is the second or greater time to obtain the area information of the passing point (S411: No) and when the area of the passing point indicated by such area information is different from the area of the previous passing point (S413: Yes), inter-area movement determiner 133 adds the area identifier corresponding to such area information (S412). Meanwhile, when the area of the passing point indicated by such area information is the same as the area of the previous passing point (S413: No), inter-area movement determiner 133 does not add the area identifier. Thereafter, the foregoing steps S410 to S412 are repeated until the area information of each of all the passing points is obtained. With this, it is possible to calculate the inter-area movement information as shown in FIG. 21.

With reference to (a) in FIG. 20 again, step S401 to step S405 are repeated thereafter until the foregoing processes are completed for all mobile objects 2 (S406: No).

When the processes are completed for all mobile objects 2 (S406: Yes), display area determiner 131 removes overlapping area identifiers from the area identifiers of the one or more first regions A11 and the area identifiers of the one or more second regions A12 that have been obtained (S407). Communicator (outputter) 11 then outputs: one or more items of area information (second information) corresponding one-to-one to the area identifiers of the one or more first regions A11 extracted by display area determiner 131; and one or more items of area information (third information) corresponding one-to-one to the area identifiers of the one or more second regions A12 extracted by display area determiner 131 (S408). At this time, when the inter-area movement information has been calculated, communicator 11 further outputs such inter-area movement information. Thereafter, the foregoing steps S401 to S408 are repeated while information processing system 1 is in operation.

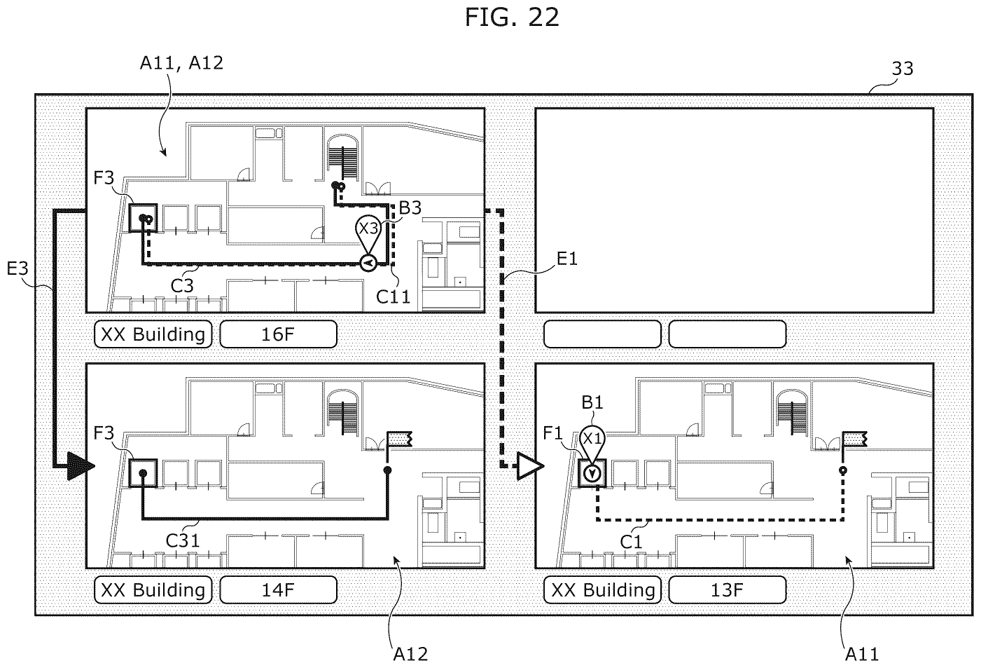

FIG. 22 is a diagram showing an example display in Working Example 4. FIG. 22 shows an example of each of the second information, the third information, and the inter-area movement information shown on display 33 of information terminal 3. In the example shown in FIG. 22, the second information includes the area information of the 13th floor and the area information of the 16th floor in “XX Building”. Also, in the example shown in FIG. 22, the third information includes the area information of the 14th floor and the area information of the 16th floor in “XX Building”. Display 33 thus shows the map of the 13th floor, the map of the 14th floor, and the map of the 16th floor in “XX Building”.

Display 33 also shows mark B1 representing the position of mobile object 2 with mobile object ID “X1”, and mark B3 representing the position of mobile object 2 with mobile object ID “X3”. Display 33 also shows movement route C3 of mobile object 2 with mobile object ID “X3” and movement route C1 of mobile object 2 with mobile object ID “X1”. Display 33 further shows future movement route C31 of mobile object 2 with mobile object ID “X3” and future movement route C11 of mobile object 2 with mobile object ID “X1”.

Display 33 shows, as the inter-area movement information, arrow E1 indicating that mobile object 2 with mobile object ID “X1” will move from the 16th floor to the 13th floor, and arrow E3 indicating that mobile object 2 with mobile object ID “X3” will move from the 16th floor to the 14th floor. Display 33 further shows, as the inter-area movement information, frame F1 representing the elevator used for the inter-area movement by mobile object 2 with mobile object ID “X1”, and frame F3 representing the elevator used for the inter-area movement by mobile object 2 with mobile object ID “X3”.

By looking at display 33, it is possible for an operator (user) to easily grasp the destinations of mobile object 2 with mobile object ID “X3” and mobile object 2 with mobile object ID “X1”.

In Working Example 5 to Working Example 9 to be described below, information processing system 1 further determines first region A11 to be preferentially shown among one or more first regions A11. More specifically, processing unit 13 calculates the priority of each of the one or more first regions A11. Each second information outputted by communicator (outputter) 11 includes information indicating the priority of the corresponding one of the one or more first regions A11 that has been calculated. Display 33 of information terminal 3 shows information related to first region A11 with a higher priority in a large size or in an emphasized manner, compared to information related to first region A11 with a low priority.

### [2-6. Working Example 5]

The following describes Working Example 5 that can be executed by information processing system 1. As with Working Example 2, Working Example 5 is executed when route information is further obtained from each of the one or more mobile objects 2. More specifically, processing unit 13 calculates the priority of each of the one or more first regions A11, on the basis of the obtained route information, to cause the priority of a region where two or more of the plurality of mobile objects 2 will pass each other to become high.

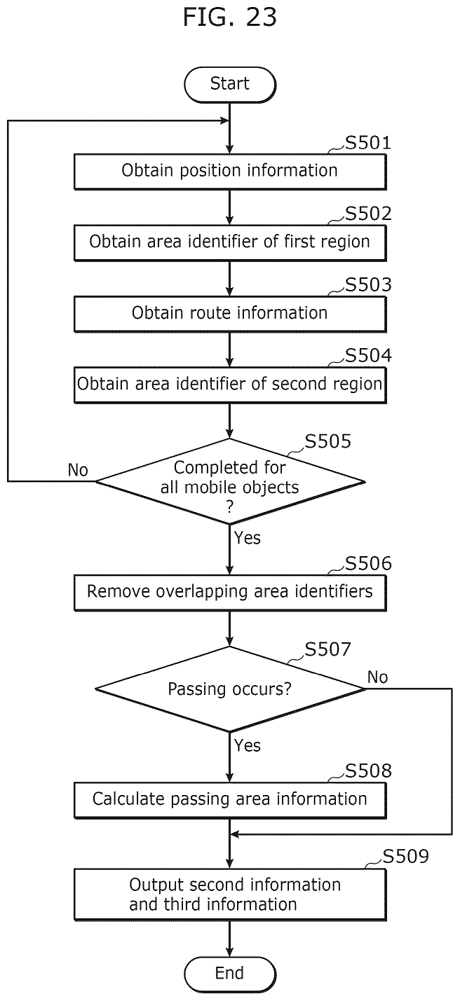

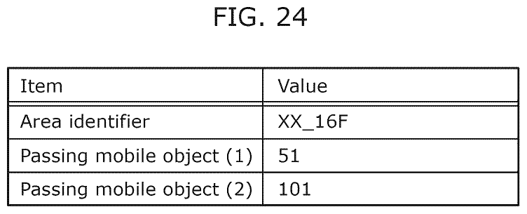

The following describes Working Example 5 in detail. The following omits detailed descriptions for the points that are common with those of Working Example 2. FIG. 23 is a flowchart showing Working Example 5 of information processing system 1 according to the embodiment. FIG. 24 is a diagram showing an example of passing area information.

In FIG. 24, “area identifier” indicates the identifier of the area where two or more mobile objects 2 will pass each other, and “passing mobile object (1)” and “passing mobile object (2)” indicate the identifiers of two or more mobile objects 2 that will pass each other. The example shown in FIG. 24 shows that mobile object 2 with mobile object ID “51” and mobile object 2 with mobile object ID “101” will pass each other in the 16th floor in “XX Building”.

First, obtainer 12 obtains the position information from one of mobile objects 2 (S501). Next, display area determiner 131 of processing unit 13 obtains, as the area identifier of first region A11, the area identifier included in the position information obtained by obtainer 12 (S502).

Next, obtainer 12 obtains the route information from the same mobile object 2 as mobile object 2 described above (S503). Display area determiner 131 of processing unit 13 then determines whether another area to be passed through is present (S204). The description here assumes that display area determiner 131 determines that another area to be passed through is present. Display area determiner 131 then obtains, as the area identifier of second region A12, an area identifier that is different from the area identifier of first region A11 (S504). Thereafter, steps S501 to S504 are repeated until the foregoing processes are completed for all mobile objects 2 (S505: No).

When the processes are completed for all mobile objects 2 (S505: Yes), display area determiner 131 removes overlapping area identifiers from the area identifiers of the one or more first regions A11 and the area identifiers of the one or more second regions A12 that have been obtained (S506).

Priority determiner 134 then determines whether two or more mobile objects 2 will pass each other in the one or more first regions A11 and the one or more second regions A12 that have been extracted (S507). More specifically, priority determiner 134 compares the movement routes or the movement ranges of mobile objects 2, and when any movement routes or movement ranges overlap, determines that these mobile object 2 will pass each other in the area that includes the overlapping movement routes or the movement ranges. When any passing will occur (S507: Yes), priority determiner 134 calculates passing area information that includes the area identifier of the area where the passing will occur (S508). Stated differently, priority determiner 134 calculates the priority to cause the priority of the area where the passing will occur to become high. Meanwhile, when no passing will occur (S507: No), priority determiner 134 does not calculate the passing area information.

Communicator (outputter) 11 then outputs: one or more items of area information (second information) corresponding one-to-one to the area identifiers of the one or more first regions A11 extracted by display area determiner 131; and one or more items of area information (third information) corresponding one-to-one to the area identifiers of the one or more second regions A12 extracted by display area determiner 131 (S509). At this time, when the passing area information has been calculated, communicator 11 further outputs such passing area information. Thereafter, the foregoing steps S501 to S509 are repeated while information processing system 1 is in operation.

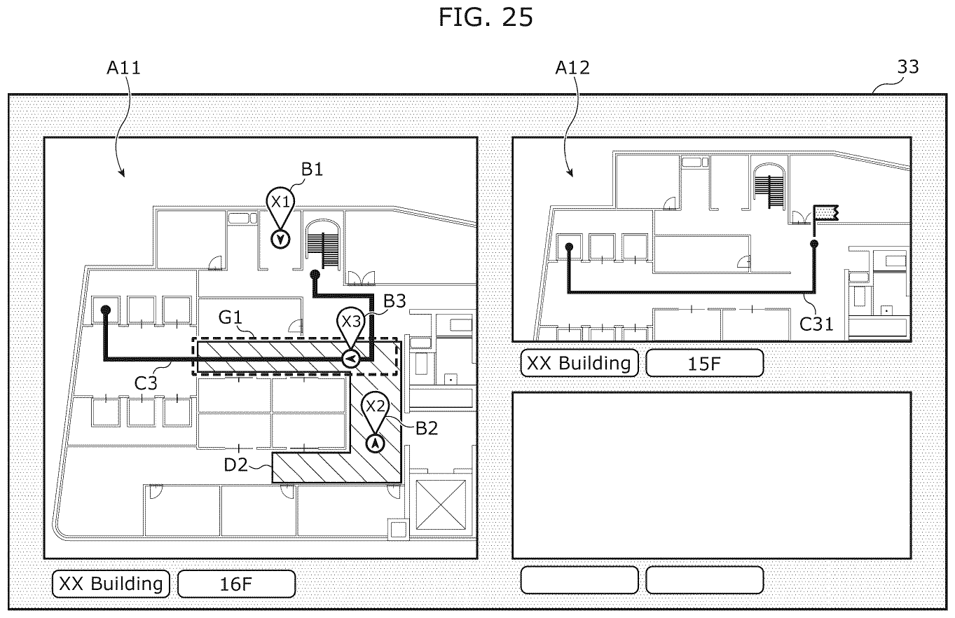

FIG. 25 is a diagram showing Display Example 1 in Working Example 5. FIG. 25 shows an example of each of the second information, the third information, and the passing area information shown on display 33 of information terminal 3. In the example shown in FIG. 25, the second information includes the area information of the 16th floor in “XX Building”. Also, in the example shown in FIG. 25, the third information includes the area information of the 15th floor in “XX Building”. Display 33 thus shows the map of the 15th floor and the map of the 16th floor in “XX Building”.

Display 33 also shows mark B1 representing the position of mobile object 2 with mobile object ID “X1”, mark B2 representing the position of mobile object 2 with mobile object ID “X2”, and mark B3 representing the position of mobile object 2 with mobile object ID “X3”. Display 33 also shows movement route C3 of mobile object 2 with mobile object ID “X3” and movement range D2 of mobile object 2 with mobile object ID “X2”. Display 33 further shows future movement route C31 of mobile object 2 with mobile object ID “X3”.

Display 33 shows, as the passing area information, area G1 representing the position where mobile object 2 with mobile object ID “X2” and mobile object 2 with mobile object ID “X3” will pass each other. Display 33 further shows, in a larger size, the area on the 16th floor, which is first region A11 where the passing will occur and thus having high priority.

By looking at display 33, it is possible for an operator (user) to easily grasp that mobile object 2 with mobile object ID “X3” and mobile object 2 with mobile object ID “X2” will pass each other.

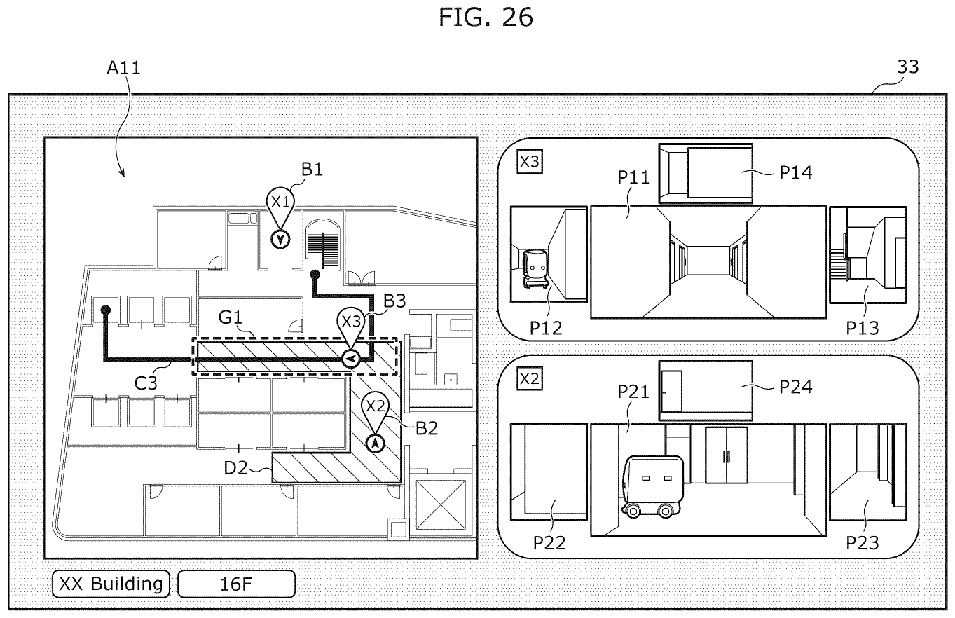

FIG. 26 is a diagram showing Display Example 2 in Working Example 5. In Display Example 2, unlike Display Example 1, display 33 of information terminal 3 shows the map of the 16th floor in “XX” building, which is first region A11 where passing will occur, and video information of each of two mobile objects 2 that are likely to pass each other. It is possible to realize Display Example 2 by means of communicator (outputter) 11 further outputting the video information of each mobile object 2 to information terminal 3. Here, display 33 shows the video information of mobile object 2 with mobile object ID “X3” and the video information of mobile object 2 with mobile object ID “X2”. The former video information includes video P11 of a forward area, video P12 of a leftward area, video P13 of a rightward area, and video P14 of a rear area of mobile object 2 with mobile object ID “X3”. The latter video information includes video P21 of a forward area, video P22 of a leftward area, video P23 of a rightward area, and video P24 of a rearward area of mobile object 2 with mobile object ID “X2”.

It is possible for an operator (user) to switch between Display Example 1 and Display Example 2 as appropriate by operating information terminal 3. In Display Example 2, it is possible for the operator to easily grasp the situation that mobile object 2 with mobile object ID “X3” and mobile object 2 with mobile object ID “X2” can pass each other, by looking at display 33.

### [2-7. Working Example 6]

The following describes Working Example 6 that can be executed by information processing system 1. Working Example 6 is executed when intervention information is further obtained from intervention information DB 42. More specifically, processing unit 13 calculates the priority of each of one or more first regions A11, on the basis of the obtained intervention information, to cause the priority of a region where an operator has intervened to become high.

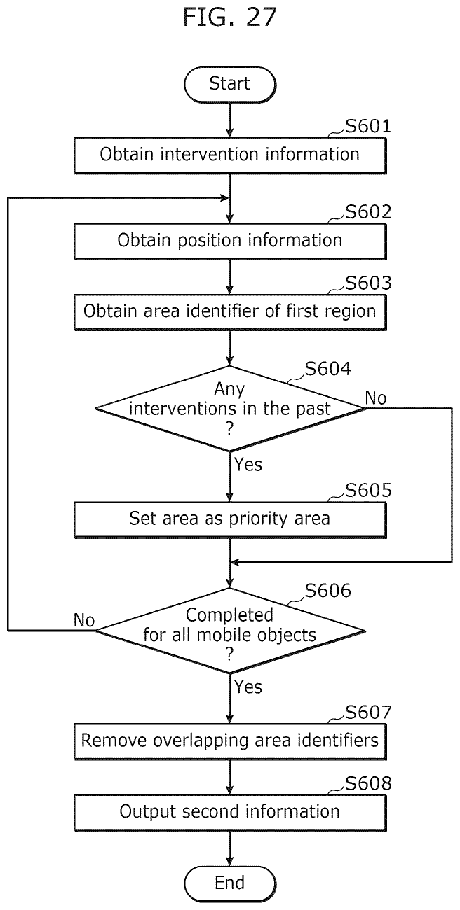

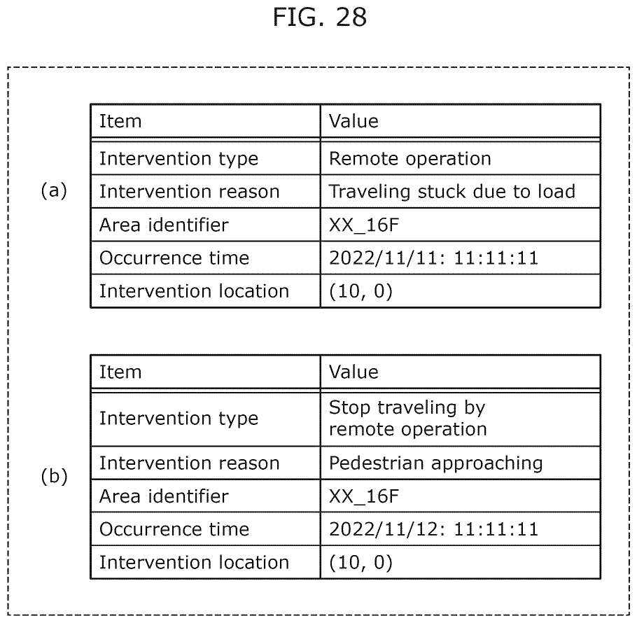

The following describes Working Example 6 in detail. The following omits detailed descriptions for the points that are common with those of the example of the basic operation. FIG. 27 is a flowchart showing Working Example 6 of information processing system 1 according to the embodiment. FIG. 28 is a diagram showing examples of the intervention information.

Each of (a) and (b) in FIG. 28 shows an example of the intervention information. In each of (a) and (b) in FIG. 28, “intervention type” indicates the type of the operator intervention, “intervention reason” indicates the reason for the operator intervention, and “area identifier” indicates the identifier of the area where an operator has intervened. “Intervention type” includes, for example, remote operation, remote stop, safety stop, route change, or on-site response by response personnel. In each of (a) and (b) in FIG. 28, “occurrence time” indicates the time at which the operator has intervened, and “intervention location” indicates the xy coordinates of the location where the operator has intervened.

First, obtainer 12 obtains the intervention information from intervention information DB 42 (S601). Next, obtainer 12 obtains the position information from one of mobile objects 2 (S602). Display area determiner 131 of processing unit 13 then obtains, as the area identifier of first region A11, the area identifier included in the position information obtained by obtainer 12 (S603).

Next, priority determiner 134 determines whether there has been an intervention by an operator in the past in first region A11 described above, on the basis of the intervention information (S604). When there has been an intervention in the past (S604: Yes), priority determiner 134 sets such first region A11 as a priority area (S605). Stated differently, priority determiner 134 calculates the priority to cause the priority of the area where an operator has intervened in the past to become high. Meanwhile, when there has been no intervention by an operator in the past (S604: No), priority determiner 134 does not set such first region A11 as a priority area.

Thereafter, steps S601 to S605 are repeated until the foregoing processes are completed for all mobile objects 2 (S606: No). When the processes are completed for all mobile objects 2 (S606: Yes), display area determiner 131 removes overlapping area identifiers from the area identifiers of the one or more first regions A11 that have been obtained (S607).

Communicator (outputter) 11 then outputs one or more items of area information (second information) corresponding one-to-one to the area identifiers of the one or more first regions A11 extracted by display area determiner 131 (S608). At this time, when a priory area has been set, communicator 11 further outputs settings information of such priority area. Thereafter, steps S601 to S608 are repeated while information processing system 1 is in operation.

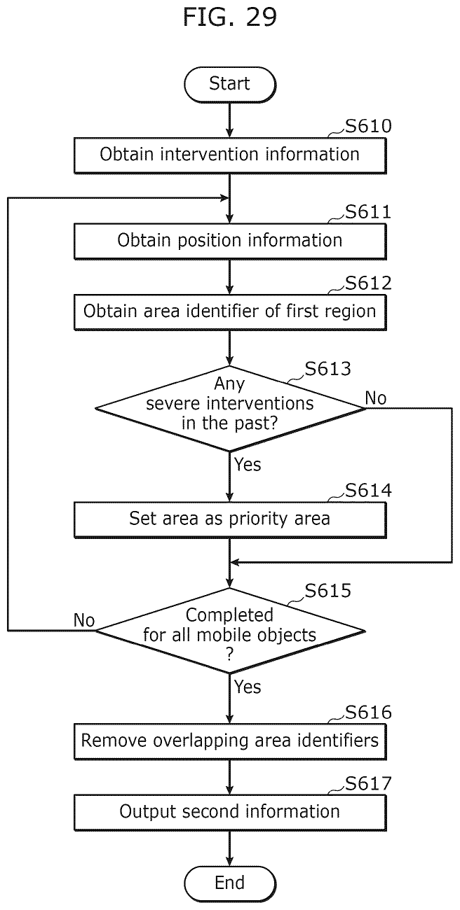

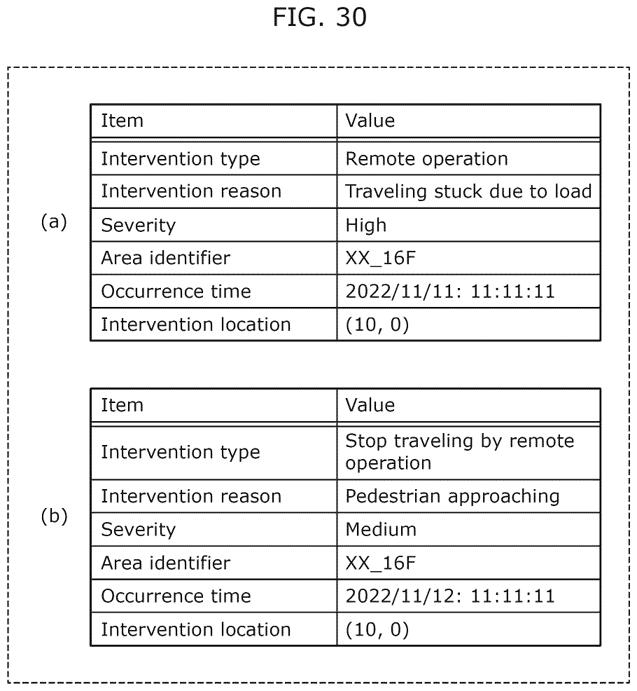

The following describes another operation in Working Example 6. FIG. 29 is a flowchart showing another operation in Working Example 6 of information processing system 1 according to the embodiment. FIG. 30 is a diagram showing other examples of the intervention information.

Each of (a) and (b) in FIG. 30 shows another example of the intervention information. Unlike the intervention information shown in each of (a) and (b) in FIG. 28, the intervention information shown in each of (a) and (b) in FIG. 30 further includes “severity”. “Severity” indicates the severity of an invention by an operator, and is represented, for example, by three levels of high, medium, and low.

In the flowchart shown in FIG. 29, steps S610, S611, S612, S615, S616, and S617 are the same as steps S601, S602, S603, S606, S607, and S608 in the flowchart shown in FIG. 27, respectively, and thus descriptions for the same steps are omitted.

Priority determiner 134 determines whether there has been a severe intervention by an operator in the past in first region A11 described above, on the basis of the intervention information (S613). More specifically, priority determiner 134 refers to the severity included in the intervention information, and determines that there has been a severe intervention by an operator in the past, when the severity is greater than a predetermined value (e.g., when the severity is at medium or higher). When there has been a severe intervention in the past (S613: Yes), priority determiner 134 sets such first region A11 as a priority area (S614). Stated differently, priority determiner 134 calculates the priority to cause the priority of the area where there has been a severe intervention by an operator in the past to become high. Meanwhile, when there has been no intervention by an operator in the past (S613: No), priority determiner 134 does not set such first region A11 as a priority area.

In Working Example 6, as with Working Example 2, information processing system 1 may extract one or more second regions A12 on the basis of the route information, and may further output the third information related to each of the one or more second regions A12 that have been extracted.

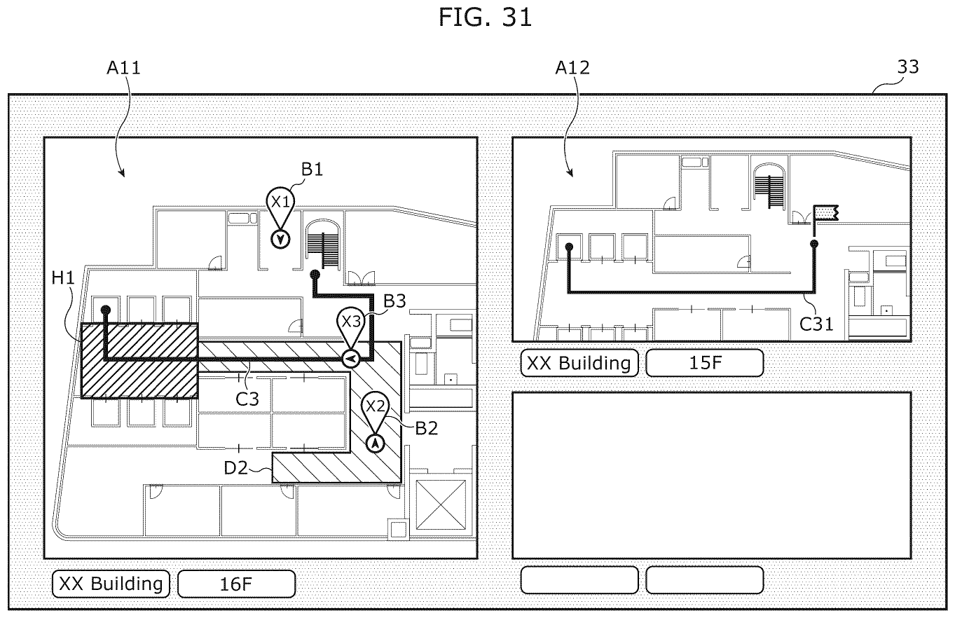

FIG. 31 is a diagram showing a display example in Working Example 6. FIG. 31 shows an example of each of the second information and the third information shown on display 33 of information terminal 3. In the example shown in FIG. 31, the second information includes the area information of the 16th floor in “XX Building”. Also, in the example shown in FIG. 31, the third information includes the area information of the 15th floor in “XX Building”. Display 33 thus shows the map of the 15th floor and the map of the 16th floor in “XX Building”.

Display 33 also shows mark B1 representing the position of mobile object 2 with mobile object ID “X1”, mark B2 representing the position of mobile object 2 with mobile object ID “X2”, and mark B3 representing the position of mobile object 2 with mobile object ID “X3”. Display 33 also shows movement route C3 of mobile object 2 with mobile object ID “X3” and movement range D2 of mobile object 2 with mobile object ID “X2”. Display 33 further shows future movement route C31 of mobile object 2 with mobile object ID “X3”.

Display 33 shows area H1 representing the location where the operator has intervened. Display 33 further shows, in a larger size, the area on the 16th floor, which is first region A11 where the operator has intervened and thus having high priority.

By looking at display 33, it is possible for an operator (user) to easily grasp that there has been an intervention by an operator in the past.

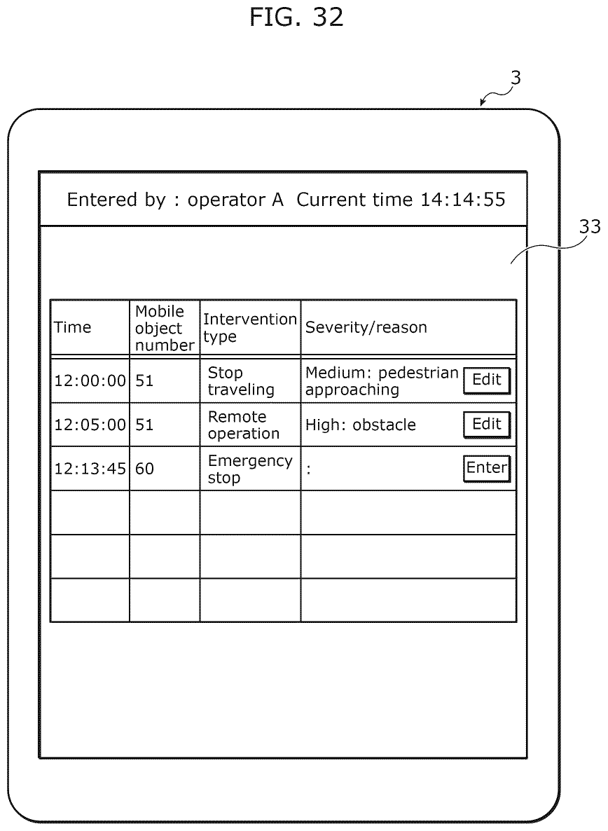

The intervention information is stored into intervention information DB 42 by, for example, an operator (user) entering the intervention information, using information terminal 3. FIG. 32 is a diagram for describing an entry of the intervention information using information terminal 3. As shown in FIG. 32, the operator enters, on the entry screen shown on display 33, the time at which the intervention has occurred, the mobile object number (mobile object ID) of mobile object 2 subjected to the intervention, the intervention type, and the severity and the reason for the intervention. Through this, the intervention information is transmitted from information terminal 3 to storage device 4 via network N1 to be stored into intervention information DB 42. Note that the severity and the intervention reason may be automatically entered, for example, on the basis of the intervention type.

### [2-8. Working Example 7]

The following describes Working Example 7 that can be executed by information processing system 1. Working Example 7 is executed when notification information is further obtained from notification information DB 43. More specifically, processing unit 13 calculates the priority of each of the one or more first regions A11, on the basis of the obtained notification information, to cause the priority of a region where the notification is provided to an operator to become high.

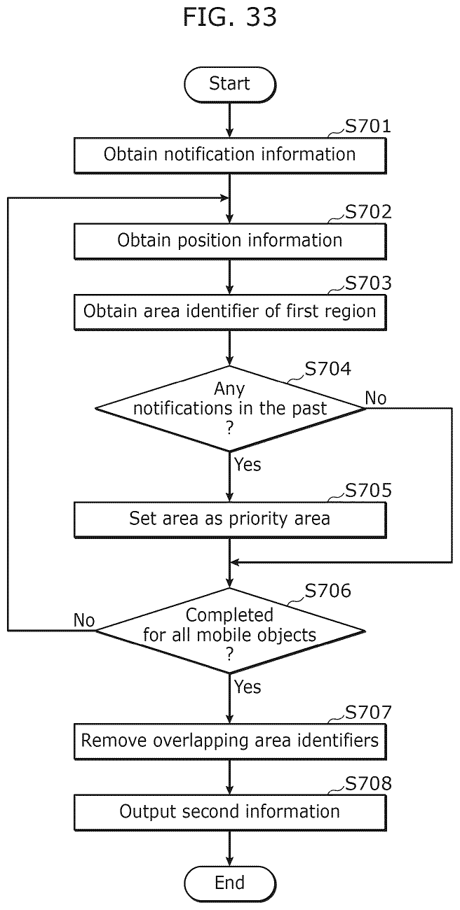

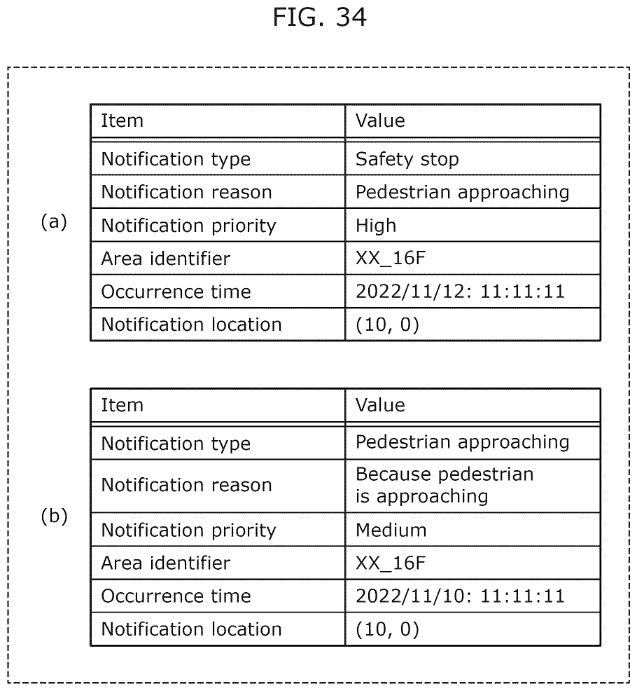

The following describes Working Example 7 in detail. The following omits detailed descriptions for the points that are common with those of the example of the basic operation. FIG. 33 is a flowchart showing Working Example 7 of information processing system 1 according to the embodiment. FIG. 34 is a diagram showing examples of the notification information.

Each of (a) and (b) in FIG. 34 shows an example of the notification information. In each of (a) and (b) in FIG. 34, “notification type” indicates the type of the notification provided from mobile object 2 to an operator, “notification reason” indicates the reason that mobile object 2 has provided the notification, and “area identifier” indicates the identifier of the area where mobile object 2 has provided the notification. “Notification type” includes, for example, pedestrian approaching, vehicle approaching, bicycle approaching, safety stop, autonomous traveling stuck, fallen object on the road, malfunction, communication anomaly, on-road parking ahead, and region ahead where traveling is not possible. Also, in each of (a) and (b) in FIG. 34, “notification priority” indicates the priority of the notification from mobile object 2, which is represented, for example, by three levels of high, medium, and low. Also, in each of (a) and (b) in FIG. 34, “occurrence time” indicates the time at which mobile object 2 has provided the notification, and “notification location” indicates the xy coordinates of the location at which mobile object 2 has provided the notification.

First, obtainer 12 obtains the notification information from notification information DB 43 (S701). Next, obtainer 12 obtains the position information from one of mobile objects 2 (S702). Display area determiner 131 of processing unit 13 then obtains, as the area identifier of first region A11, the area identifier included in the position information obtained by obtainer 12 (S703).

Next, priority determiner 134 determines whether a notification has been provided in the past in first region A11 described above, on the basis of the notification information (S704). More specifically, priority determiner 134 refers to the notification priority in the notification information, and determines that a notification has been provided in the past, when the notification priority is greater than a predetermined value (e.g., when the notification priority is at medium or higher). When a notification has been provided in the past (S704: Yes), priority determiner 134 sets such first region A11 as a priority area (S705). Stated differently, priority determiner 134 calculates the priority to cause the priority of the area where the notification has been provided in the past to become high. Meanwhile, when no notification has been provided in the past (S704: No), priority determiner 134 does not set such first region A11 as a priority area.

Thereafter, step S701 to step S705 are repeated until the foregoing processes are completed for all mobile objects 2 (S706: No). When the processes are completed for all mobile objects 2 (S706: Yes), display area determiner 131 removes overlapping area identifiers from the area identifiers of the one or more first regions A11 that have been obtained (S707).

Communicator (outputter) 11 then outputs one or more items of area information (second information) corresponding one-to-one to the area identifiers of the one or more first regions A11 extracted by display area determiner 131 (S708). At this time, when a priory area has been set, communicator 11 further outputs settings information of such priority area. Thereafter, steps S701 to S708 are repeated while information processing system 1 is in operation.

In Working Example 7, as with Working Example 2, information processing system 1 may extract one or more second regions A12 on the basis of the route information, and may further output the third information related to each of the one or more second regions A12 that have been extracted.

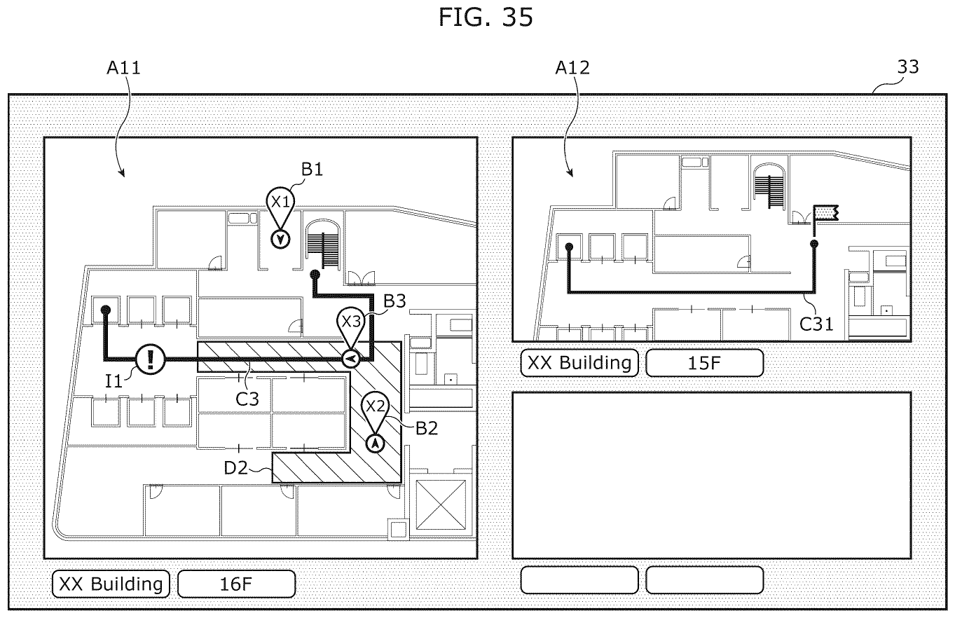

FIG. 35 is a diagram showing a display example in Working Example 7. FIG. 35 shows an example of each of the second information and the third information shown on display 33 of information terminal 3. In the example shown in FIG. 35, the second information includes the area information of the 16th floor in “XX Building”. Also, in the example shown in FIG. 35, the third information includes the area information of the 15th floor in “XX Building”. Display 33 thus shows the map of the 15th floor and the map of the 16th floor in “XX Building”.

Display 33 also shows mark B1 representing the position of mobile object 2 with mobile object ID “X1”, mark B2 representing the position of mobile object 2 with mobile object ID “X2”, and mark B3 representing the position of mobile object 2 with mobile object ID “X3”. Display 33 also shows movement route C3 of mobile object 2 with mobile object ID “X3” and movement range D2 of mobile object 2 with mobile object ID “X2”. Display 33 further shows future movement route C31 of mobile object 2 with mobile object ID “X3”.

Display 33 shows mark I1 representing the location where mobile object 2 has provided the notification. Display 33 further shows, in a larger size, the area on the 16th floor, which is first region A11 where mobile object 2 has provided the notification and thus having high priority.

By looking at display 33, it is possible for an operator (user) to easily grasp that mobile object 2 has provided a notification in the past.

### [2-9. Working Example 8]

The following describes Working Example 8 that can be executed by information processing system 1. Working Example 8 is executed when traffic information is further obtained from traffic information DB 44. More specifically, processing unit 13 calculates the priority of each of one or more first regions A11, on the basis of the obtained traffic information, to cause the priority of a region with a large traffic volume to become high.

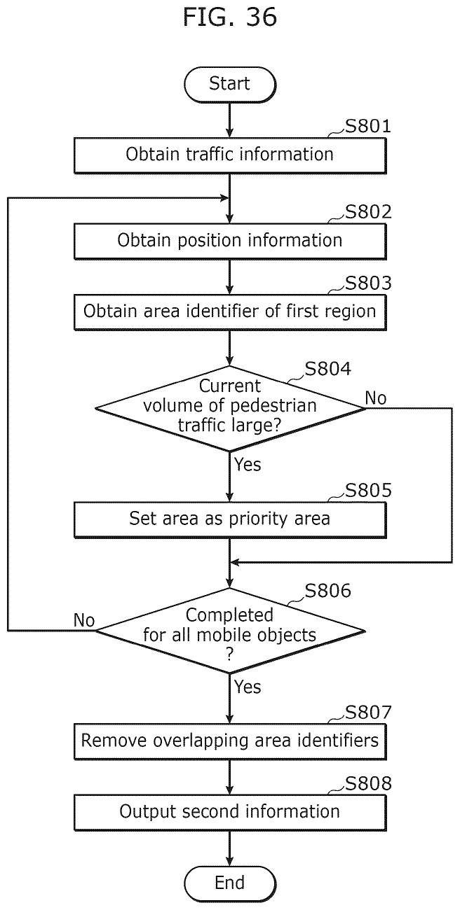

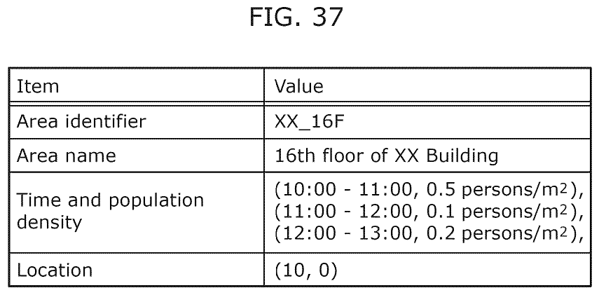

The following describes Working Example 8 in detail. The following omits detailed descriptions for the points that are common with those of the example of the basic operation. FIG. 36 is a flowchart showing Working Example 8 of information processing system 1 according to the embodiment. FIG. 37 is a diagram showing an example of the traffic information.

In FIG. 37, “area identifier” indicates the identifier of the area, “area name” indicates the name of the area, “time and population density” indicates the population density per unit time (in this case, one hour), and “location” indicates the xy coordinates of the location where the population density is measured.

First, obtainer 12 obtains notification information from traffic information DB 44 (S801). Next, obtainer 12 obtains the position information from one of mobile objects 2 (S802). Display area determiner 131 of processing unit 13 then obtains, as the area identifier of first region A11, the area identifier included in the position information obtained by obtainer 12 (S803).

Next, priority determiner 134 determines whether there is currently a large volume of pedestrian traffic in first region A11 described above, on the basis of the traffic information (S804). More specifically, priority determiner 134 refers to the time and population density in the traffic information, and determines that there is currently a large volume of pedestrian traffic, when the population density at the time of the determination is greater than a predetermined value. When determining that there is a large volume of pedestrian traffic (S804: Yes), priority determiner 134 sets such first region A11 as a priority area (S805). Stated differently, priority determiner 134 calculates the priority to cause the priority of the area with a large volume of traffic to become high. Meanwhile, when determining that there is not currently a large volume of pedestrian traffic (S804: No), priority determiner 134 does not set such region A11 as a priority area.

Thereafter, steps S801 to S805 are repeated until the foregoing processes are completed for all mobile objects 2 (S806: No). When the processes are completed for all mobile objects 2 (S806: Yes), display area determiner 131 removes overlapping area identifiers from the area identifiers of the one or more first regions A11 that have been obtained (S807).

Communicator (outputter) 11 then outputs one or more items of area information (second information) corresponding one-to-one to the area identifiers of the one or more first regions A11 extracted by display area determiner 131 (S808). At this time, when a priory area has been set, communicator 11 further outputs settings information of such priority area. Thereafter, steps S801 to S808 are repeated while information processing system 1 is in operation.

In Working Example 8, as with Working Example 2, information processing system 1 may extract one or more second regions A12 on the basis of the route information, and may further output the third information related to each of the one or more second regions A12 that have been extracted.

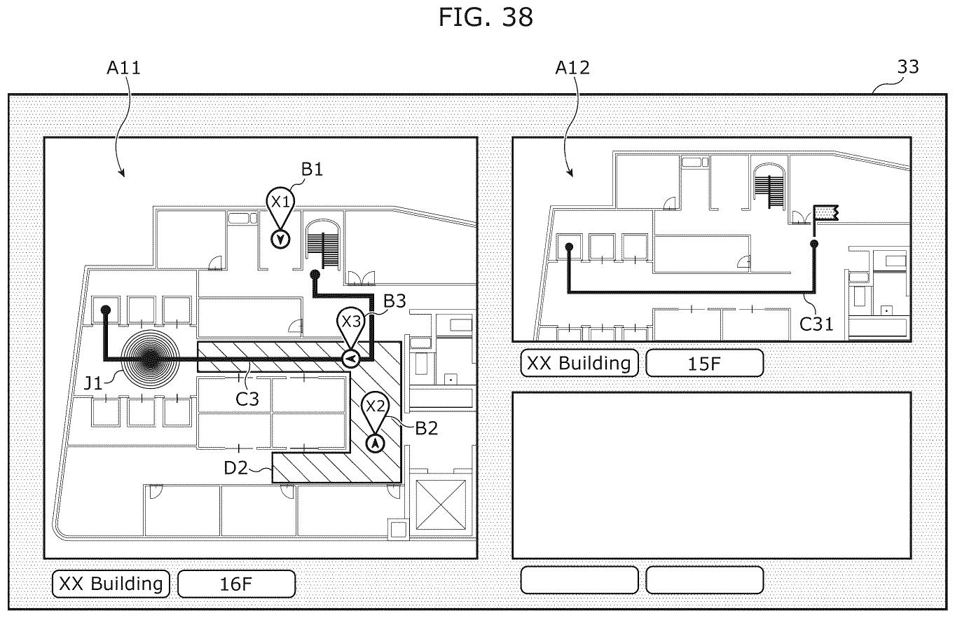

FIG. 38 is a diagram showing a display example in Working Example 8. FIG. 38 shows an example of each of the second information and the third information shown on display 33 of information terminal 3. In the example shown in FIG. 38, the second information includes the area information of the 16th floor in “XX Building”. Also, in the example shown in FIG. 38, the third information includes the area information of the 15th floor in “XX Building”. Display 33 thus shows the map of the 15th floor and the map of the 16th floor in “XX Building”.

Display 33 also shows mark B1 representing the position of mobile object 2 with mobile object ID “X1”, mark B2 representing the position of mobile object 2 with mobile object ID “X2”, and mark B3 representing the position of mobile object 2 with mobile object ID “X3”. Display 33 also shows movement route C3 of mobile object 2 with mobile object ID “X3” and movement range D2 of mobile object 2 with mobile object ID “X2”. Display 33 further shows future movement route C31 of mobile object 2 with mobile object ID “X3”.

Display 33 shows heat map J1 showing the position where there is currently a large volume of pedestrian traffic (with a large traffic volume). Display 33 further shows, in a larger size, the area on the 16th floor, which is first region A11 currently with a large amount of pedestrian traffic and thus having high priority.

By looking at display 33, it is possible for an operator (user) to easily grasp a position with a large traffic volume.

### [2-10. Working Example 9]

The following describes Working Example 9 that can be executed by information processing system 1. Working Example 9 is executed when the state information obtained from each mobile object 2 includes information indicating the number of persons who are present in the vicinity of mobile object 2 (stated differently, traffic information). More specifically, processing unit 13 calculates the priority of each of one or more first regions A11, on the basis of the traffic information included in the obtained state information, to cause the priority of a region with a large traffic volume to become high.

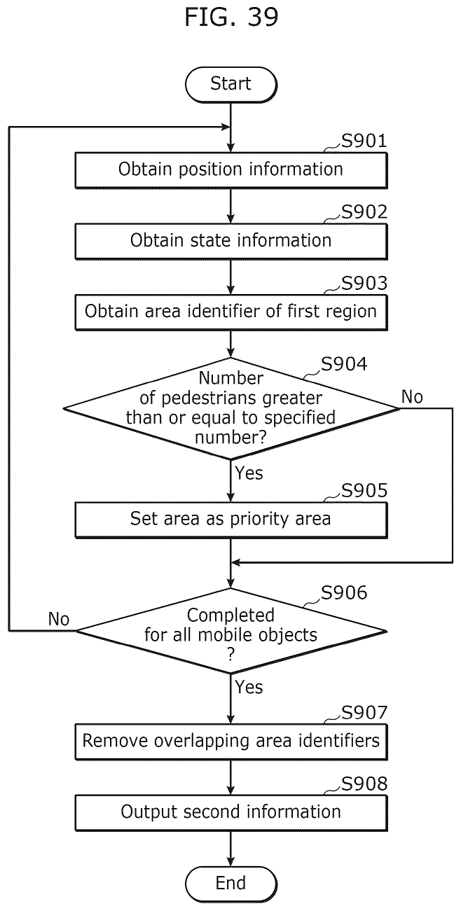

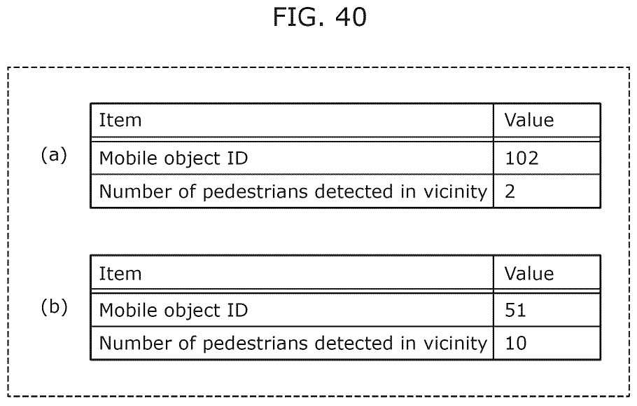

The following describes Working Example 9 in detail. The following omits detailed descriptions for the points that are common with those of the example of the basic operation. FIG. 39 is a flowchart showing Working Example 9 of information processing system 1 according to the embodiment. FIG. 40 is a diagram showing other examples of the state information.

Each of (a) and (b) in FIG. 40 shows another example of the state information. In each of (a) and (b) in FIG. 40, “mobile object ID” indicates the identifier assigned to mobile object 2, and “number of pedestrians detected in vicinity” indicates the number of pedestrians detected in the vicinity of mobile object 2. It is possible to obtain “number of pedestrians detected in vicinity” by, for example, mobile object 2 performing, as appropriate, image analysis processing on captured video and detecting pedestrians included in the video.

First, obtainer 12 obtains the position information from one of mobile objects 2 (S901). Next, obtainer 12 obtains the state information from the same mobile object 2 as mobile object 2 described above (S902). Display area determiner 131 of processing unit 13 then obtains, as the area identifier of first region A11, the area identifier included in the position information obtained by obtainer 12 (S903).

Next, priority determiner 134 determines whether the number of pedestrians in first region A11 described above is greater than or equal to a specified number, on the basis of the traffic information included in the state information (S904). More specifically, priority determiner 134 refers to the number of pedestrians detected in the vicinity included in the state information, and determines that the number of pedestrians is greater than or equal to the specified number, when the number of pedestrians detected in the vicinity at the time of the determination is greater than a predetermined value. When determining that the number of pedestrians is greater than or equal to the specified number (S904: Yes), priority determiner 134 sets such first region A11 as a priority area (S905). Stated differently, priority determiner 134 calculates the priority to cause the priority of the area with a large traffic volume to become high. Meanwhile, when determining that the number of pedestrians is less than the specified number (S904: No), priority determiner 134 does not set such first region A11 as a priority area.

Thereafter, steps S901 to S905 are repeated until the foregoing processes are completed for all mobile objects 2 (S906: No). When the processes are completed for all mobile objects 2 (S906: Yes), display area determiner 131 removes overlapping area identifiers from the area identifiers of the one or more first regions A11 that have been obtained (S907).

Communicator (outputter) 11 then outputs one or more items of area information (second information) corresponding one-to-one to the area identifiers of the one or more first regions A11 extracted by display area determiner 131 (S908). At this time, when a priory area has been set, communicator 11 further outputs settings information of such priority area. Thereafter, steps S901 to S908 are repeated while information processing system 1 is in operation.

In Working Example 9, as with Working Example 2, information processing system 1 may extract one or more second regions A12 on the basis of the route information, and may further output the third information related to each of the one or more second regions A12 that have been extracted.

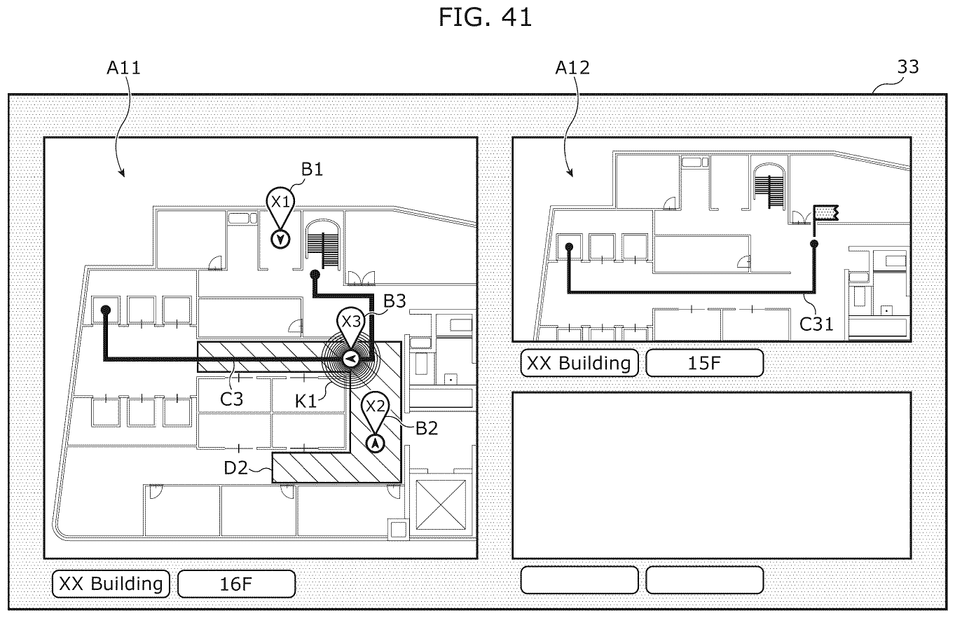

FIG. 41 is a diagram showing a display example in Working Example 9. FIG. 41 shows an example of each of the second information and the third information shown on display 33 of information terminal 3. In the example shown in FIG. 41, the second information includes the area information of the 16th floor in “XX Building”. Also, in the example shown in FIG. 41, the third information includes the area information of the 15th floor in “XX Building”. Display 33 thus shows the map of the 15th floor and the map of the 16th floor in “XX Building”.

Display 33 also shows mark B1 representing the position of mobile object 2 with mobile object ID “X1”, mark B2 representing the position of mobile object 2 with mobile object ID “X2”, and mark B3 representing the position of mobile object 2 with mobile object ID “X3”. Display 33 also shows movement route C3 of mobile object 2 with mobile object ID “X3” and movement range D2 of mobile object 2 with mobile object ID “X2”. Display 33 further shows future movement route C31 of mobile object 2 with mobile object ID “X3”.

Display 33 shows heat map K1 showing the position where the number of pedestrians is greater than or equal to the specified number (with a large traffic volume). Display 33 further shows, in a larger size, the area on the 16th floor, which is first region A11 where the number of pedestrians is greater than or equal to the specified number and thus having high priority.

By looking at display 33, it is possible for an operator (user) to easily grasp a position with a large traffic volume.

### [3. Advantages, etc.]

As described above, the information processing method and information processing system 1 according to the embodiment extract, from the plurality of regions A1, one or more first regions A11 where one or more mobile objects 2 are present, and output the second information related to each of the one or more first regions A11 that have been extracted. With this, by displaying the second information on display 33 of information terminal 3, for example, not all of regions A1, but one or more first regions A11 where the one or more mobile objects 2 are present are shown. This enables an increased amount of information to be shown for each region on display 33. It is thus possible for an operator (user) to more easily grasp the situation of each mobile object 2 by looking at display 33.

As described above, the information processing method and information processing system 1 according to the embodiment are capable of presenting, to the user, not all items information related to the plurality of regions A1, but only information related to each of one or more first regions A11 where one or more mobile objects 2 are present. The information processing method and information processing system 1 thus achieve the advantage of enabling the user to easily grasp the usage status of each of the one or more mobile objects 2.

### OTHER EMBODIMENTS

The information processing method information processing system 1 according to one or more aspects of the present disclosure have been described above on the basis of the embodiment, but the present disclosure is not limited to such embodiment. The scope of one or more aspects of the present disclosure may also include an embodiment achieved by making various modifications to the embodiment that can be conceived by those skilled in the art and an embodiment achieved by combining some of the elements in different embodiments, without departing from the essence of the present disclosure.

The following recites Variation 1 to Variation 5 of the display shown on display 33 of information terminal 3.

### <Variation 1>

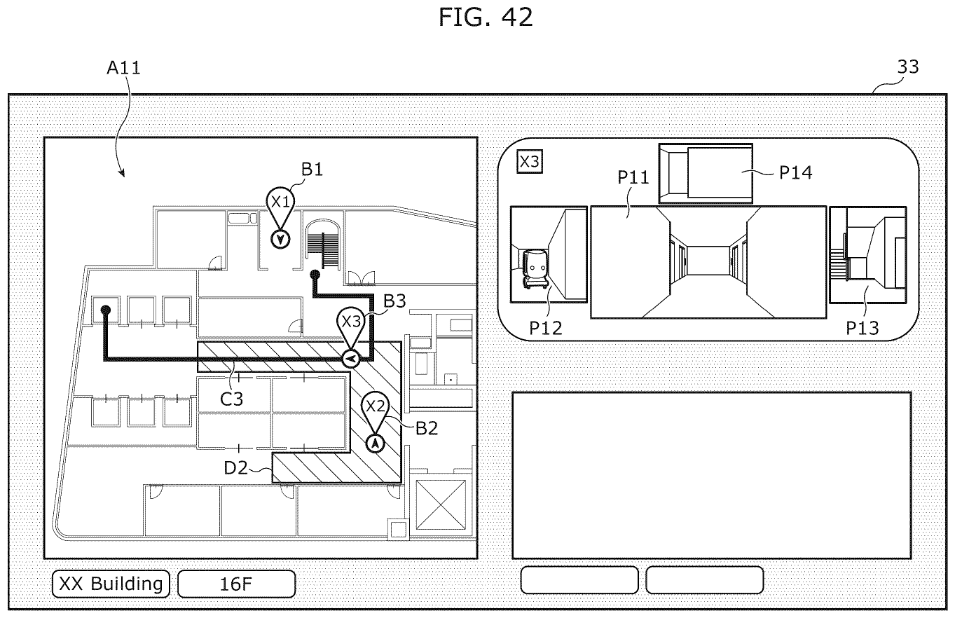

FIG. 42 is a diagram showing Variation 1 of the display shown on display 33 of information terminal 3. In the present variation, as shown in FIG. 42, when an operator (user) selects any one of the marks representing mobile objects 2, display 33 shows video information of mobile object 2 corresponding to such mark. In the example shown in FIG. 42, the operator is selecting mark B3 representing mobile object 2 with mobile object ID “X3”. As such, display 33 shows video P11 of a forward area, video P12 of a leftward area, video P13 of a rightward area, and video P14 of a rearward area of mobile object 2 with mobile object ID “X3”. The present variation is realized by communicator (outputter) 11 further outputting the video information of each mobile object 2 to information terminal 3.

By looking at display 33, it is possible for the operator (user) to easily grasp the situation in the vicinity of mobile object 2.

### <Variation 2>

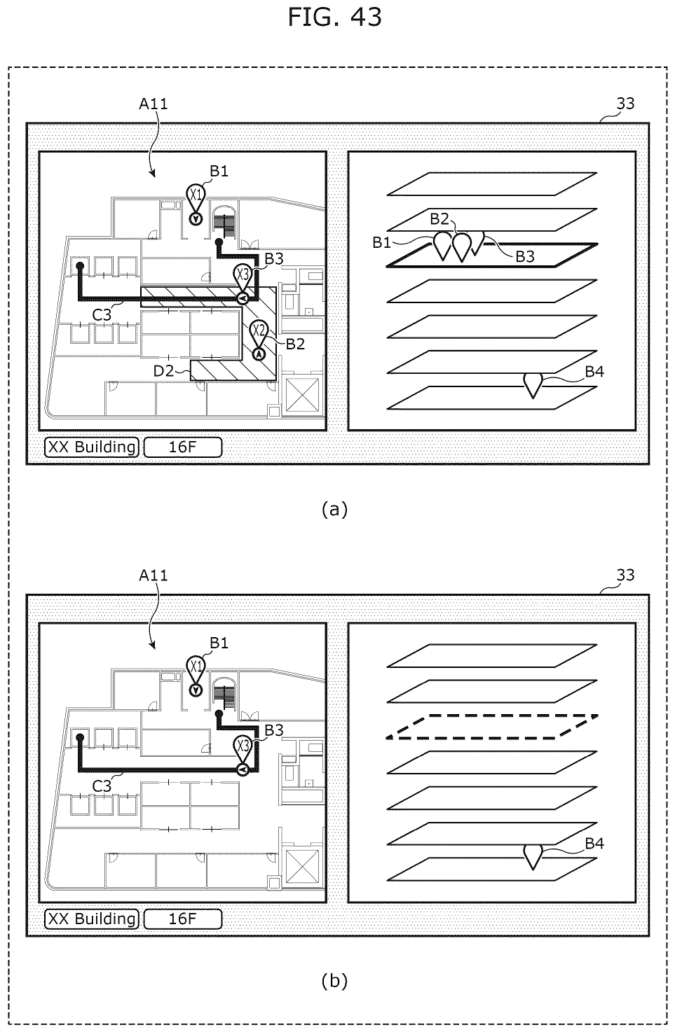

FIG. 43 is a diagram showing Variation 2 of the display shown on display 33 of information terminal 3. In the present variation, as shown in (a) in FIG. 43, display 33 shows an area with a high priority among one or more first regions A11 and an image showing a floor structure of the plurality of regions A1. Such image shows one or more marks (in this case, marks B1 to B4) representing one or more mobile objects 2. By looking at display 33, it is possible for an operator (user) to easily grasp the position of mobile object 2 that is present in an area other than an area with a high priority, while grasping the situation of such area with a high priority. The foregoing image showing the floor structure may not show the area that is currently shown on display 33, as shown in (b) in FIG. 43.

By looking at display 33, it is possible for the operator (user) to grasp not only mobile object 2 that is present in an area with a high priority, but also mobile object 2 that is present in another area, although in a simple manner.

### <Variation 3>

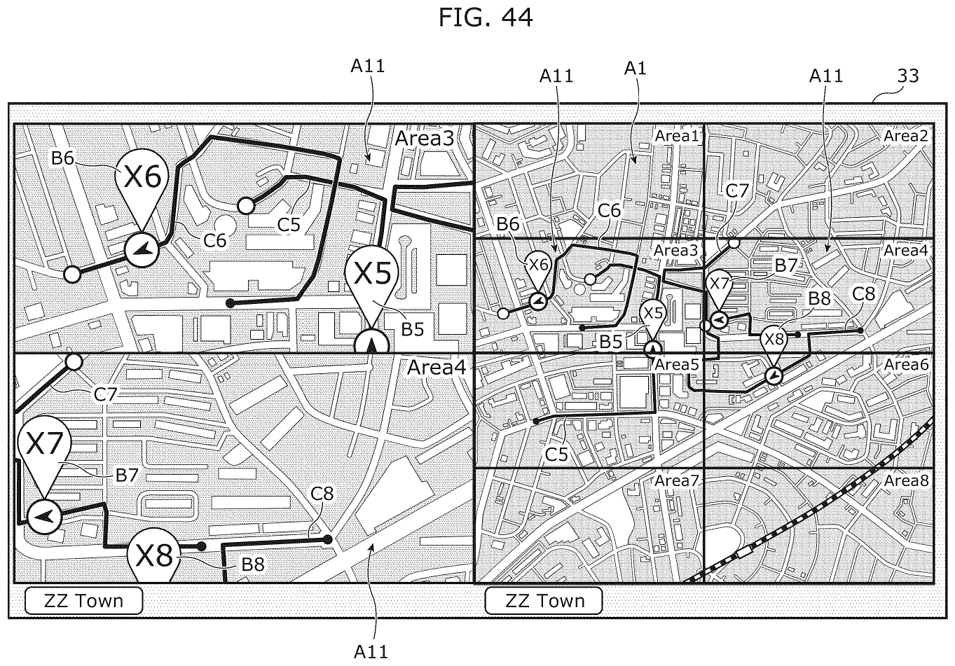

FIG. 44 is a diagram showing Variation 3 of the display shown on display 33 of information terminal 3. In the present variation, as shown in FIG. 44, the plurality of regions A1 are not a plurality of floors in the facility, but are a plurality of divided regions into which the site is divided at a certain range. In the example shown in FIG. 44, the second information includes the area information of “Area 3” in “ZZ Town”, which is first region A11, and the area information of “Area 4” in “ZZ Town”, which is first region A11. Display 33 thus shows the map of “Area 3” and the map of “Area 4” in “ZZ Town”. Note that, in the example shown in FIG. 44, display 33 shows the map showing the most part of the plurality of regions A1, but display 33 may not show such map.

Display 33 also shows mark B5 representing the position of mobile object 2 with mobile object ID “X5”, mark B6 representing the position of mobile object 2 with mobile object ID “X6”, mark B7 representing the position of mobile object 2 with mobile object ID “X7”, and mark B8 representing the position of mobile object 2 with mobile object ID “X8”. Display 33 further shows movement routes C5, C6, C7, and C8 of mobile objects 2 with mobile object IDs “X5”, “X6”, “X7”, and “X8”, respectively. Note that display 33 shows movement routes C5, C6, C7, and C8 of mobile objects 2, when information processing system 1 obtains the route information.

By looking at display 33, it is possible for an operator (user) to easily grasp the situation of each of the one or more mobile objects 2 that are present in the site.

### <Variation 4>

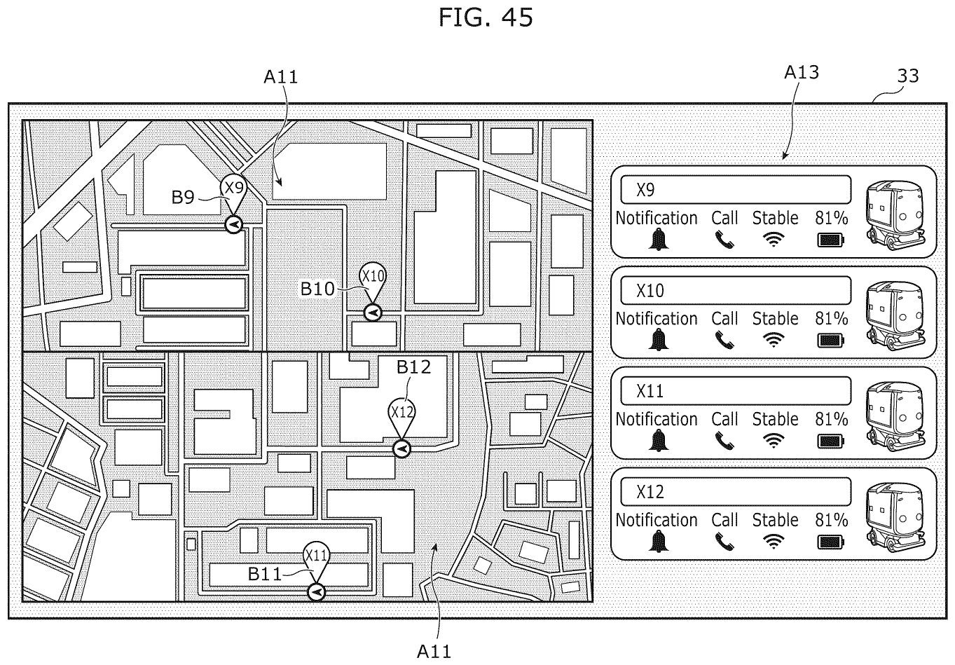

FIG. 45 is a diagram showing Variation 4 of the display shown on display 33 of information terminal 3. In the present example, as shown in FIG. 45, display 33 shows: one or more areas (in this case, two areas) with a high priority among one or more first regions A11; and list A13 that shows an overview of one or more mobile objects 2 (in this case, four mobile objects 2) that are present in such one or more areas.

Display 33 also shows mark B9 representing the position of mobile object 2 with mobile object ID “X9”, mark B10 representing the position of mobile object 2 with mobile object ID “X10”, mark B11 representing the position of mobile object 2 with mobile object ID “X11”, and mark B12 representing the position of mobile object 2 with mobile object ID “X12”.

List A13 shows, for each mobile object 2, the mobile object ID, an image of mobile object 2, and images representing the states of mobile object 2. The images representing the states of mobile object 2 include, from the left, an image representing that there is a notification from mobile object 2, an image representing whether calling with mobile object 2 is possible, an image representing the state of communication with mobile object 2, and an image representing the remaining battery power of mobile object 2. In addition, when there is any notifications from mobile object 2, a number indicating the number of notifications is shown in the upper right of the image of mobile object 2.

Note that, in list A13, mobile object 2 in an area with a higher priority, for example, may be shown in a higher position in list A13. Also, the order in which mobile objects 2 are shown in list A13 may be updated at regular time intervals.

By looking at display 33, it is possible for an operator (user) to easily grasp the state of each of the one or more mobile objects 2.

### <Variation 5>

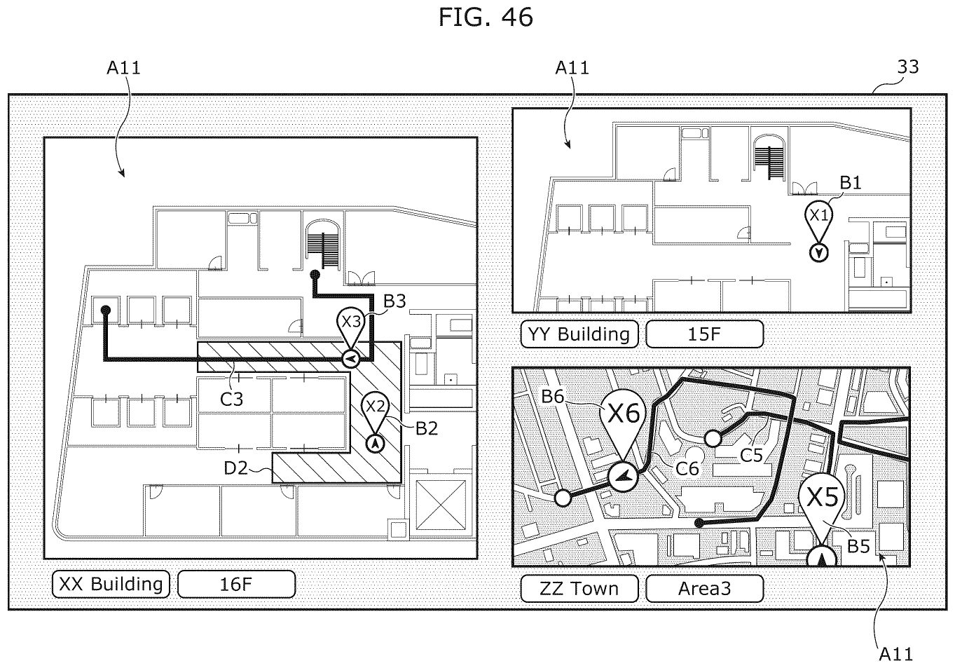

FIG. 46 is a diagram showing Variation 5 of the display shown on display 33 of information terminal 3. In the present variation, as shown in FIG. 46, display 33 shows one or more areas (in this case, three areas) with a high priority among one or more first regions A11 in each of a plurality of monitoring targets. In this case, the plurality of monitoring targets are the facilities “XX Building” and “YY Building”, and the site “ZZ Town”.

In the example shown in FIG. 46, the second information includes the area information of the 16th floor, which is first region A11 with a high priority in “XX Building”, the area information of the 15th floor, which is first region A11 with a high priority in “YY Building”, and the area information of “Area 3”, which is first region A11 with a high priority in “ZZ Town”. Display 33 thus shows the map of the 16th floor in “XX Building”, the map of the 15th floor in “YY Building”, and the map of “Area 3” in “ZZ Town”.

Display 33 also shows marks B2 and B3 representing the positions in “XX Building” of mobile objects 2 with mobile object IDs “X2” and “X3”, respectively, mark B1 representing the position in “YY Building” of mobile object 2 with mobile object ID “X1”, and marks B5 and B6 representing the positions in “ZZ Town” of mobile objects 2 with mobile object IDs “X5” and “X6”, respectively. Display 33 further shows movement range D2 of mobile object 2 with mobile object ID “X2”, movement route C3 of mobile object 2 with mobile object ID “X3”, and movement routes C5 and C6 of mobile objects 2 with mobile object IDs “X5” and “X6”, respectively. Note that display 33 shows movement routes C3, C5, and C6, and movement range D2 of mobile objects 2, in the case where information processing system 1 obtains the route information.

By looking at display 33, it is possible for an operator (user) to easily grasp the state of each of the one or more mobile objects 2 in each of the plurality of monitoring targets.

### <Other Variations>

In Display Example 5 in Working Example 2 described above, for example, whether to cause display 33 to show the detailed screen (see FIG. 17A) or the entire screen (see FIG. 17B) is switched in accordance with an operation performed by an operator (user) using information terminal 3, but the present disclosure is not limited to this. The detailed screen and the entire screen may be automatically switched, for example, in response to any one of the following as a trigger: the occurrence of an event in mobile object 2 that should be monitored; an increase or decrease in the number of mobile objects 2 in each area; a change in the travel route or the travel range of mobile object 2; a change in the traveling state of mobile object 2; time; and a change in traffic volume. When an event that should be monitored occurs in mobile object 2 in any one of the areas, while display 33 is showing the entire screen, for example, the entire screen may be switched to the detailed screen that shows such area.

In the display example in Working Example 4 described above (see FIG. 22), for example, display 33 may show that mobile object 2 is moving using an elevator. In the example shown in FIG. 22, for example, when mobile object 2 is moving using an elevator, inter-area movement of mobile object 2 may be shown in an emphasized manner, for example, by means of the blinking of arrows E1, E3, etc. representing such inter-area movement. Note that such emphasized display is not limited to being applied to the movement of mobile object 2 using an elevator; when mobile object 2 is moving in infrastructure that is used to move between areas, such as a corridor connecting buildings, for example, such infrastructure may be shown in an emphasized manner.

In each of the display examples in the foregoing embodiment, for example, display 33 may show, in the same color, the color of the mark representing the position of mobile object 2 and the color of the movement route of the corresponding mobile object 2. Display 33 may also show, in the same color, the color of the mark and the color of the movement range of the corresponding mobile object 2. Also, when display 33 shows the mobile object ID of each mobile object 2, for example, display 33 may show, in the same color, the color of the mark and the color of the mobile object ID of the corresponding mobile object 2.

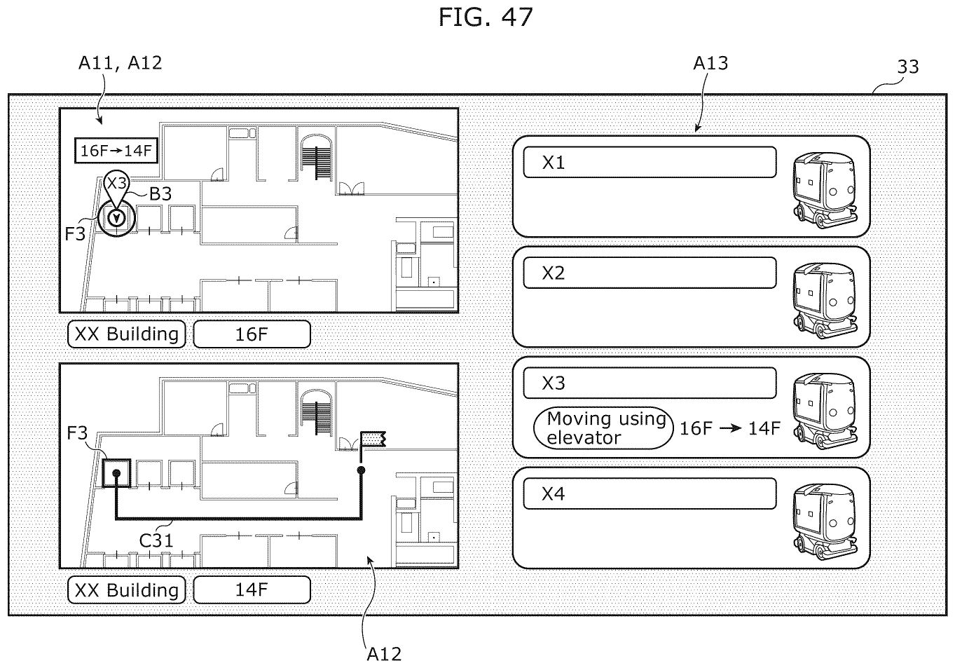

When display 33 shows list A13 showing an overview of one or more mobile objects 2 that are present in areas with a high priority as shown in Variation 4 described above, for example, display 33 may show inter-area movement of two mobile objects 2, when these mobile objects 2 are moving across two areas, as shown in FIG. 47. FIG. 47 is a diagram showing further another variation of the display shown on display 33 of information terminal 3. In the example shown in FIG. 47, list A13 showing an overview of mobile objects 2 indicates that mobile object 2 with mobile object ID “X3” is moving from the 16th floor to the 14th floor using an elevator.

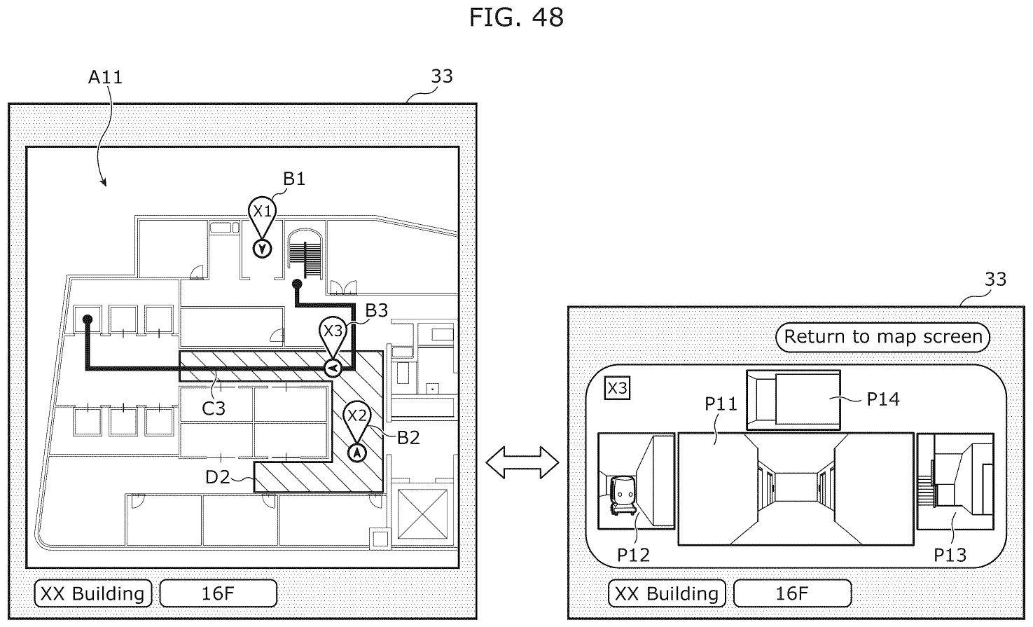

In Variation 1 described above, when an operator (user) selects any one of the marks representing mobile objects 2, for example, display 33 shows the video information of mobile object 2 corresponding to such selected mark together with the map, but the present disclosure is not limited to this. As shown in FIG. 48, for example, a state in which display 33 shows only the map and a state in which display 33 shows only the video information may be alternatively switched.

FIG. 48 is a diagram showing further another variation of Variation 1 of the display shown on display 33 of information terminal 3. In the example shown in FIG. 48, when an operator selects mark B3 representing mobile object 2 with mobile ID “X3”, the screen of display 33 showing the map is switched to the screen showing videos P11 to P14 of mobile object 2 with mobile ID “X3”. Note that, when “return to map screen” icon is selected on display 33 that is showing videos P11 to P14 of mobile object 2, the screen is switched to the former screen that shows the map.

In the foregoing embodiment, for example, the timing for updating an area with a high priority shown on display 33 (such timing is hereinafter referred to as “update timing”) includes the timing at which an operator (user) intervenes or at which mobile object 2 is directly operated. The update timing also includes, for example, the timing at which an alert is obtained from mobile object 2, such as an alert of a low battery power or a request for remote operation. The update timing also includes, for example, the timing at which the route or the movement range of mobile object 2 is changed. The update timing also includes, for example, the timing at which the traffic volume changes in an area where mobile object 2 moves or in an area where a service detected by infrastructure is carried out. The update timing also includes, for example, the timing at which a preliminarily set time is reached.

In Display Example 2 in the example of the basic operation described above, for example, the items of information related to first regions A11 to be shown on display 33 are switched every fixed time period as shown in the example in FIG. 6, but the present disclosure is not limited to this. When processing unit 13 has calculated the priority of each of the one or more first regions A11, for example, display 33 may show first region A11 with a high priority for an increased length of time. In the example shown in FIG. 6, for example, display 33 alternately shows the area information of the 14th floor and the area information of the 16th floor in “XX Building”, but when the priority of the area information of the 14th floor is higher, display 33 may show the area information of the 14th floor for a longer length of time than the area information of the 16th floor.

In the foregoing embodiment, for example, information processing system 1 is simply required to be capable of performing at least the example of the basic operation. Stated differently, information processing system 1 only needs to include the elements required to carry out a working example, among Working Example 1 to Working Example 9 described above. When information processing system 1 performs only the example of the basic operation, for example, belonging area determiner 132 and priority determiner 134 are not required. Also, when information processing system 1 performs only the example of the basic operation, for example, route obtainer 23, state obtainer 24, and video obtainer 25 are not required. When information processing system 1 performs only the example of the basic operation, for example, storage device 4 is not required to include intervention information DB 42, notification information DB 43, and traffic information DB 44.

Also, the present disclosure can be realized, for example, in the form of a program for causing a processor to execute the steps included in the information processing method. The present disclosure can be further realized in the form of a non-transitory, computer-readable recording medium, such as a CD-ROM, having recorded thereon such program.

When the present disclosure is realized in the form of a program (software), for example, the steps are executed by means of the program being executed using hardware resources of a computer, such as a central processing unit (CPU), memory, and an input-output circuit. Stated differently, the steps are executed by the CPU obtaining data from, for example, the memory or the input-output circuit to perform calculations, and outputting calculation results to, for example, the memory or the input-output circuit.

Note that each of the elements included in information processing system 1 in the foregoing embodiment may be configured in the form of an exclusive hardware product, or may be realized by executing a software program suitable for the element. Each of the elements may be realized by means of a program executing unit, such as a CPU and a processor, reading and executing the software program recorded on a recording medium such as a hard disk or a semiconductor memory.

The functions of information processing system 1 according to the foregoing embodiment are, in part or in whole, realized in the form of a large-scale integration (LSI), which is typically an integrated circuit. The functions of information processing system 1 may take the form of individual chips, or may be encapsulated into a single chip to encompass these in part or in whole. The functions of information processing system 1 are not limited to being integrated into LSIs, and thus may be realized in the form of exclusive circuits or general-purpose processors. A field programmable gate array (FPGA) that allows for programming after the manufacture of an LSI, or a reconfigurable processor that allows for reconfiguration of the connection and the settings of circuit cells inside an LSI may also be employed.

Further, the scope of the present disclosure also includes various variations achieved by making modifications to the embodiment of the present disclosure that can be conceived by those skilled in the art without departing from the essence of the present disclosure.

### INDUSTRIAL APPLICABILITY

The present disclosure is applicable to a system that manages one or more mobile objects.

1. An information processing method executed by a computer, the information processing method comprising:
obtaining first information related to a region where each of one or more mobile objects is present;
extracting one or more first regions where the one or more mobile objects are present, among a plurality of regions, based on the first information obtained; and
outputting second information related to each of the one or more first regions extracted.

2. The information processing method according to claim 1,
wherein the second information includes at least one of: information indicating a map of each of the one or more first regions; or information indicating a position of each of the one or more mobile objects in the one or more first regions.

3. The information processing method according to claim 1, further comprising:
obtaining route information related to at least one of a movement route or a movement range of each of the one or more mobile objects;
extracting one or more second regions, among the plurality of regions, based on the route information obtained, the one or more second regions each being a region where the one or more mobile objects have been present before the obtaining of the first information or where the one or more mobile objects can be present after the obtaining of the first information; and
outputting third information related to each of the one or more second regions extracted.

4. The information processing method according to claim 3,
wherein at least one of the second information or the third information includes information indicating at least one of the movement route or the movement range of each of the one or more mobile objects.

5. The information processing method according to claim 1,
wherein the first information includes information indicating a position of each of the one or more mobile objects, and
the one or more first regions are extracted based on the information indicating the position of each of the one or more mobile objects.

6. The information processing method according to claim 1, further comprising:
obtaining state information related to a state of each of the one or more mobile objects,
wherein the one or more first regions are extracted further based on the state information obtained.

7. The information processing method according to claim 1, further comprising:
calculating a priority of each of the one or more first regions,
wherein the second information includes information indicating the priority of each of the one or more first regions that has been calculated.

8. The information processing method according to claim 7,
wherein the one or more mobile objects are a plurality of mobile objects, and
the information processing method further comprises:
obtaining route information related to at least one of a movement route or a movement range of each of the plurality of mobile objects, and
the priority of each of the one or more first regions is calculated based on the route information obtained, to cause a priority of a region where two or more of the plurality of mobile objects pass each other to become high, among the plurality of regions.

9. The information processing method according to claim 7, further comprising:
obtaining intervention information indicating that an operator who is remotely monitoring the one or more mobile objects has intervened,
wherein the priority of each of the one or more first regions is calculated based on the intervention information obtained, to cause a priority of a region where the operator has intervened to become high.

10. The information processing method according to claim 7, further comprising:
obtaining notification information indicating that a notification has been provided from the one or more mobile objects to an operator who is remotely monitoring the one or more mobile objects,
wherein the priority of each of the one or more first regions is calculated based on the notification information obtained, to cause a priority of a region where the notification has been provided to the operator to become high.

11. The information processing method according to claim 7, further comprising:
obtaining traffic information related to traffic in each of the one or more first regions,
wherein the priority of each of the one or more first regions is calculated based on the traffic information obtained, to cause a priority of a region with a large traffic volume to become high.

12. A non-transitory computer-readable recording medium having recorded thereon a program for causing a computer to execute the information processing method according to claim 1.

13. An information processing system comprising:
an obtainer that obtains first information related to a region where each of one or more mobile objects is present;
a processing unit that extracts one or more first regions where the one or more mobile objects are present, among a plurality of regions, based on the first information obtained by the obtainer; and
an outputter that outputs second information related to each of the one or more first regions extracted by the processing unit.

14. An information terminal comprising:
a display;
a communicator that communicates with the information processing system according to claim 13 to obtain the second information from the information processing system; and
a terminal processing unit that causes the display to display the second information obtained by the communicator.
